(19) United States
(12) Patent Application Publication
(10) Pub. No.: US 2015/0289449 A1
(43) Pub. Date: Oct. 15, 2015

(54) Bale Handler

(71) Applicant: Brent Lee Greer, Nibley, UT (US)

(72) Inventor: Brent Lee Greer, Nibley, UT (US)

(21) Appl. No.: 14/248,743

(22) Filed: Apr. 9, 2014

(51) Int. Cl. A01D 90/08; A01D 90/10

(52) U.S. Cl. CPC A01D 90/083; A01D 90/10

(57) ABSTRACT

A bale handler having a crane on a bed on a vehicle outside the storage area of the bed to place round bales of hale on the bed, preferably into individual storage tubs in order to facilitate knowing the precise location of such bales in order to facilitate automation. Some embodiments combine a lifting arm mechanism with the crane. The lifting arm mechanism is capable of grasping a round bale of hay, lifting the bale, releasing it on the bed, retrieving it from the bed, and unrolling the round bale. Optionally, the bale hander comprises an auger for breaking the hay into particles to facilitate livestock eating such hay and for discharging such particles onto the ground or into a livestock feed bunk.

### BACKGROUND OF THE INVENTION

1. Field of the Invention

This invention relates to a device for handling, viz., retrieving, loading, transporting, unloading, and feeding, bales of agricultural material, especially large, round bales of hay.

2. Description of the Related Art

Numerous patents and patent publications exist for bale handlers; and there is are several patents for cranes that, although not specifically intended to lift bales, are capable of doing so.

Such bale handlers use one of two devices for retrieving hay bales from the ground. The first is a traditional crane—varying from a very basic model to industrial versions. The second is known by a variety of names in the art but herein will be termed a lifting arm mechanism. It has two arms, one of which goes on one side of a bale and the other of which goes on another side of the bale. Each arm rotates about an upper portion of the arm, just as a human arm rotates about a person's shoulder, to lift the bale from the ground and onto a wheeled carrier.

U.S. Pat. Nos. 4,091,943; 4,363,583; 4,498,829; 4,552,501; 5,607,274; 5,725,346; 5,975,832; and 6,220,811 all involve bale handlers which utilize some form of crane but have no lifting arm mechanism and no tubs to accommodate individual bales.

On the contrary, U.S. Pat. Nos. 4,329,101; 4,952,111; 5,340,259; 5,405,229; 5,618,146; 6,312,205; 7,004,706; 7,241,098; 7,419,345; 7,481,612; 8,112,202; and 8,152,429 as well as United States patent publication nos. 20110014014 and 20110271647 employ lifting arm mechanisms but have neither cranes nor tubs to accommodate individual bales. Only the lifting arm of U.S. Pat. No. 5,618,146 is stated to be capable of unloading the bales; and none of these patents have a motorized rotatable bale gripper for unrolling a round bale or an auger to receive hay from an unrolled bale and break the hay into smaller pieces to facilitate the eating of such hay by animals.

Several cranes, however, have a cargo holding device which can rotate in both the pitch (parallel to the last segment of the boom on the crane) place and the yaw (perpendicular to the pitch plane) plane, but none of the cargo holding devices are specifically intended to hold a hay bale.

The device of international publication number WO 87/01684 has, mounted to the bed of a truck, a fully functional crane, i.e., the boom 13 of the crane 10 can rotate in both the pitch (the plane containing the boom of the crane) and yaw (a plane that is perpendicular to the pitch plane and that contains the last segment of the boom of the crane) planes and can also be extended. Moreover, the lifting fork 29, consisting of “two parallel supporting arms 35 . . . rigidly secured to a transversal back portion 36 of the lifting fork at their rear ends,” can independently be moved in the pitch and yaw planes. This device has, however, no curved tubs for securely accommodating round hay bales, no lifting arm mechanism, and no programmed computer for automating its operation.

For the crane of U.S. Pat. No. 3,554,395, the patent states, in lines 19 through 20 of column 3, “A hydraulic cylinder 39 on the hoisting fork 21 is retracted to tilt the arms 40 of the hoisting fork 21.” And the patent also indicates, in lines 39 through 40 of column 3, “The hydraulic ‘wrist’ 36 . . . is used for rotating the hoisting fork 21 . . . . ” As with the patent discussed in the preceding paragraph, this crane has no curved tubs for securely accommodating round hay bales, no lifting arm mechanism, and no programmed computer for automating its operation. And the hoisting fork 21, which U.S. Pat. No. 3,554,395 states “ . . . is described in greater detail in my U.S. Pat. No. 3,239,072,” is rotatably suspended from the boom (Actually, in the case of U.S. Pat. No. 3,554,395, as opposed to U.S. Pat. No. 3,239,072, a wrist 36 to which the fork is attached is rotatably suspended from the boom.) so that the forks 40 would rotate backward rather than piercing and entering a hay bale. Such suspension and its resultant effect is, moreover, also true for the crane of U.S. Pat. No. 4,552,501.

In U.S. Pat. No. 4,280,785 a “multi-directional lifting and handling device is mounted on the end of a standard telescoping crane boom.” Such device can rotate in both the pitch and yaw planes. Again, though, the crane has no curved tubs for securely accommodating round hale bales, no lifting arm mechanism, and no programmed computer for automating its operation.

And U.S. Pat. No. 6,478,427 explains how a camera at the end of a boom may rotate in the yaw plane but, for rotation in the pitch plane, simply states, “According to an additional feature of the invention, the camera 32 may further rotate about a horizontal tilt axis 252. As illustrated in FIG. 3, this coupling may be accomplished by controls known in the art. And, of course, the this camera crane has no curved tubs for securely accommodating round hay bales, no lifting arm mechanism, and no programmed computer for automating its operation.

Cargo holding devices for cranes and lifting arm mechanisms are known to be of four types suitable for holding a bale of hay, including a large, round bale.

The first type will herein be termed a pincher claw. This is illustrated, for a crane, in U.S. Pat. No. 4,552,501 and involves a first set of hooks which are able to penetrate the bale on a first side of the highest point of the bale while an opposing set of hooks penetrate the bale on the opposite side of the highest point of the bale.

The term herein for the second will be grappling arms. An illustration of this, for a crane, is provided in U.S. Pat. No. 4,363,583 and involve a set of arms and an opposing set of arms which together are capable of encircling the top and more than fifty percent of each side of a bale, thereby extending below the elevation of the center of the bale.

Third is one or more forks which embodiment is illustrated, for a lifting arm mechanism, in United States patent publication no. 20110271647 and utilizes one or more forks to pierce a bale, preferably from the end of the bale.

Finally, a cradle which holds a bale by supporting a lower portion of such bale is illustrated, for a lifting arm mechanism, in United States patent publication no. 20110271647.

For bale loaders with lifting arm mechanisms those of U.S. Pat. Nos. 4,952,111; 7,419,345; 7,481,612; and 8,112,202 all provide for automated loading.

And the Summary of the Invention for U.S. Pat. No. 4,091,943, which utilizes a crane (termed a “gripping device”) to load and unload bales on and from a vehicle, explains:

“Any suitable known type of programmable control means may be used in connection with the method and loading apparatus of the present invention and may be of a mechanical, electrical, or electronic type, and preferably of a type making it possible to select one of a number of possible movement programs. For example, the automatic control means may be programmed in such a manner that the bales are loaded onto the vehicle in superposed layers which are mutually bonded. The substantially improved bond between the bales in each layer and between adjacent layers substantially reduces the risk that a stack formed by tilting a number of truck loads in the manner previously described overturns.

“The method according to the invention also makes it possible to obtain other types of automatic unloading of the bales. Thus, the gripping device may successively unload the bales from the vehicle if the automatic control means is programmed so as to unload the bales in the inverse order in relation to the loading operation. The unloading position or bale releasing position may for example be fixed under the unloading operations. Thus, the automatic control means may for example be programmed in such a manner that all of the bales are unloaded and released at the same position on a conveyor which may then convey the bales to a storing site. However, it is also possible to program the automatic control means in such a manner that the gripping device will unload the bales and arrange them in superposed and preferably mutually bonded layers.”

Although directed toward using overhead cranes handling and stacking pressed bales in a bale storage facility, one of ordinary skill the art would be able to utilize the computers and software of U.S. Pat. No. 6,074,155 for automatically loading and unloading a bale loader. That patent states:

“To further optimize the facility, it is recommended that a control covering the entire facility be provided for the stacking device(s), the intermediate storage areas and possibly the delivery station(s). As a result, the bale storage facility can be operated and managed, for the most part, automatically.

“The control may contain a computer with a storage facility management software and with a data bank for the virtual storage or stacking places. The location in the storage facility and the relevant, product-related data, such as the identity of the bale, the type of bale or fiber, the size of the bale, the fiber grade, the date of manufacture, etc., are stored in it. Due to the absence of a fixed subdivision of the storage facility, as it is present in a shelf-type storage facility with permanent storage places, the locations within the storage facility are determined and stored in relation to one another in the bale storage facility management system.

“For the storage facility management, the control has a computer with a storage facility management program and a data bank for the virtual stacking or storage places of the bales 2 and possibly with a sorting program. Data on the storage location of the pressed bale 2, the identity of the bales, the type of the bale or fiber, the fiber grade, the bale size, the type of packaging, the date of manufacture, and other desired product-related or other relevant properties of the bale are stored in the data bank in suitable data records.”

### BRIEF SUMMARY OF THE INVENTION

The Bale Handler of the present invention utilizes a crane to load round bales onto a bed of a truck or trailer. Preferably, such bed comprises an individual tub for each bale with the bottom of the tub sloped so as to cause a bale placed in such tub to move to the longitudinal and transverse center of the tub. This facilitates automating loading and unloading of the bed since the precise location of each bale will be known.

Preferably, the Bale Handler also comprises a lifting arm mechanism for retrieving a bale from the ground and placing it on a transitional platform for movement by the crane to its ultimate intended location on the bed.

Also preferably, the lifting arm mechanism has on each of two arms a bale gripper. Each bale gripper has projections for securely holding an end of the bale, with the projections of a first bale gripper entering, when the first bale gripper is used, a first end of a bale and with the projections of the second bale gripper entering, when the second bale gripper is used, a second end of the bale. Both bale grippers are preferably rotatable, and at least one of the bale grippers is preferably motorized. The lifting arm mechanism can grasp a round bale on the transitional platform, lower it toward the ground, and unroll such round bale.

Even more preferably, an auger, preferably twin adjacent augers, is located in an auger assembly attached to the lifting arm mechanism in such a position as to receive the hay as it is unrolled from a round bale. Such auger breaks the hay into smaller pieces to facilitate the eating of such hay by animals, particularly livestock. (As used herein the term “auger” covers a traditional single auger but also and, preferably, includes twin adjacent augers.)

Another preferred option is, in order to facilitate placement of a bale on the bed, to have the cargo holding device for the crane be attached to the distal end of the crane and be rotatable in both the pitch plane, i.e., the plane containing the boom of the crane, and the yaw plane, i.e., a plane that is perpendicular to the pitch plane and that contains the last segment of the crane. And even more preferably, such cargo holding device comprises a base from which one or more forks project in order to pierce an end of a bale, although the cargo holding device can be any of those discussed above.

And, lastly, using any technique known to one of ordinary skill in the art, the process of loading and unloading is preferably automated.

### BRIEF DESCRIPTION OF THE SEVERAL VIEWS OF THE DRAWING

FIG. 1 is an elevational view taken from the front of a self-propelled bale handler with its lifting arm mechanism rotated down into the operational position.

FIG. 2 is an elevational view taken from the right side of a self-propelled bale handler with its lifting arm mechanism rotated down into the operational position.

FIG. 3 is an elevational view taken from the right side of a self-propelled bale handler with its lifting arm mechanism rotated down into the operational position and with the boom of its crane extended.

FIG. 4 is an elevational view taken from the front of a self-propelled bale handler with its lifting arm mechanism rotated upward into the storage position and with the crane either placing a bale of hay on the ground or retrieving a bale of hay from the ground.

FIG. 5 is a plan view taken from above a self-propelled bale handler with its lifting arm mechanism rotated down into the operational position and with the boom of the crane extended either for placing a bale of hay on the bed of the bale handler or for retrieving a bale of hay from the bed of the bale handler.

FIG. 6 is a partial plan view taken from above a self-propelled bale handler with its lifting arm mechanism rotated down into the operational position and with the crane in a stored position.

FIG. 7 is an elevational partial view taken from the left of a semi-trailer embodiment of the bale handler with the crane either just having placed a bale on an upper row or just ready to remove a bale from an upper row on the bed of the semi-trailer.

FIG. 8 is an elevational view taken from the left of a semi-trailer embodiment of the bale handler with the crane either just having placed a bale on a lower row or just ready to remove a bale from a lower row on the bed of the semi-trailer.

FIG. 9 is a plan view taken from above a semi-trailer embodiment of the bale handler with the crane either just having placed a bale on the semi-trailer or just removing a bale from the semi-trailer.

FIG. 10 is an elevational view taken from the right side of a tractor-pulled bale handler with its lifting arm mechanism rotated down into the operational position.

FIG. 11 is a plan view taken from above a tractor-pulled bale handler with its lifting arm mechanism rotated down into the operational position and with the crane in a stored position.

FIG. 12 is an elevational partial view taken from the right side of a self-propelled bale handler with its lifting arm mechanism rotated upward into the storage position.

FIG. 13 is a plan view taken from above a self-propelled bale handler that is unrolling a bale of hay.

FIG. 14 is an elevational view from the front of a self-propelled bale loader having its lifting arm mechanism rotated down into the operational position with an auger assembly attached to the lifting arm mechanism in such a position as to receive the hay as it is unrolled from a round bale in order to break the hay into smaller pieces and to distribute such pieces, for example, into a livestock feeding bunk as illustrated.

FIG. 15 is an elevational view taken from the right side of the auger assembly, with the auger in an auger housing and having a feeder box leading to such auger housing, attached to the lifting arm mechanism.

FIG. 16 is an elevational view taken from the front of the lifting arm mechanism with the attached auger assembly.

FIG. 17 is an elevational view taken from the rear of any embodiment of the bale handler other that the drop-bed semi-trailer bale handler.

FIG. 18 is an elevational view taken from a side of any embodiment of the bale handler showing how round bales can be less than precisely located longitudinally when a tub runs the longitudinal length of the bed, being curved only in the transverse direction.

FIG. 19 is an elevational view taken from a side of any embodiment of the bale handler illustrating individual tubs for round bales which are curved in the transverse direction, the longitudinal ends of which tubs are also curved, and the longitudinal length of each tub being such that a standard round bale will simultaneously touch both longitudinal ends of the tub and thereby slide to the longitudinal center of the tub as well as the transverse center of the tub, being, therefore, precisely located.

FIG. 20 is an elevational view taken from the front showing the lifting arms and an alternate embodiment of the attached bale grippers with the bale grippers in a retracted position and, in phantom, with the bale grippers extended to grasp a bale of hay.

FIG. 21 is an elevational view taken from the right side of the lifting arm mechanism with an attached auger assembly, portraying the lifting mechanism as a bale is being raised from the transitional platform.

FIG. 22 is a plan view taken from above a semi-trailer embodiment of the bale handler with the crane either just having placed a bale on the semi-trailer or just removing a bale from the semi-trailer and having two outriggers extended on the left side and two outriggers extended on the right side of the semi-trailer.

FIG. 23 is an elevational view taken from the left of a drop-bed semi-trailer bale handler with the crane in a stored position.

FIG. 24 is a plan view taken from above the drop-bed semi-trailer bale handler with the crane in a position for loading or unloading.

FIG. 25 is an elevational view taken from the rear of the drop-bed semi-trailer bale handler.

### DETAILED DESCRIPTION OF THE INVENTION

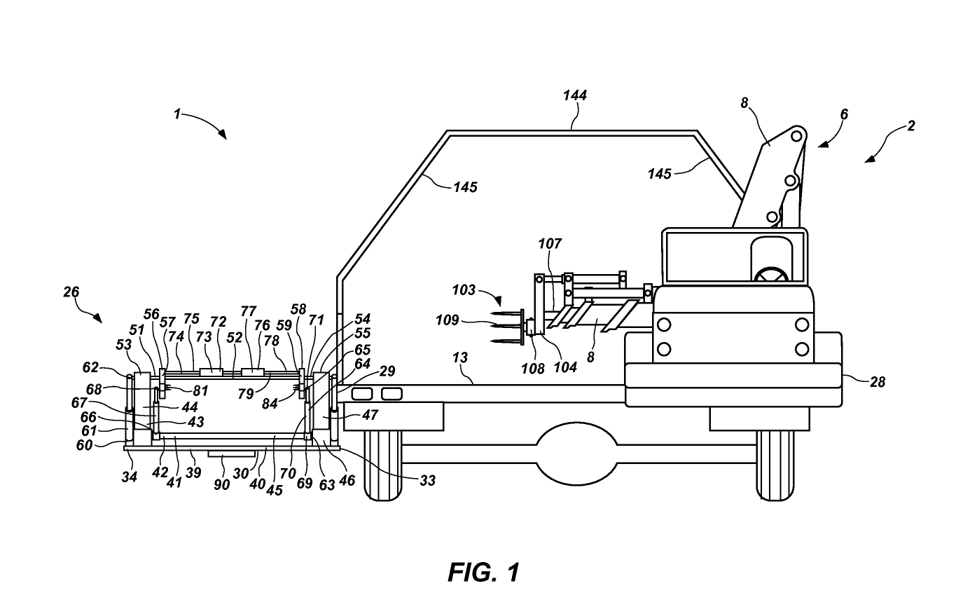

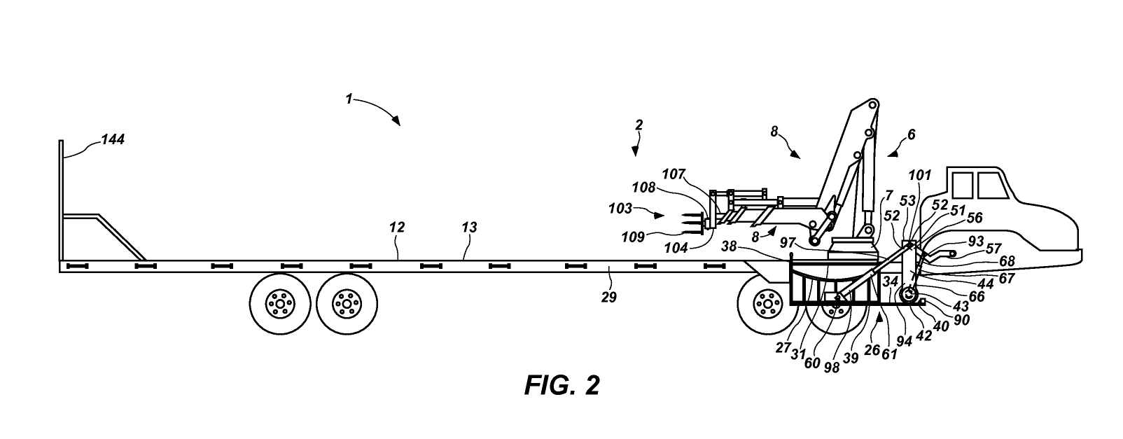

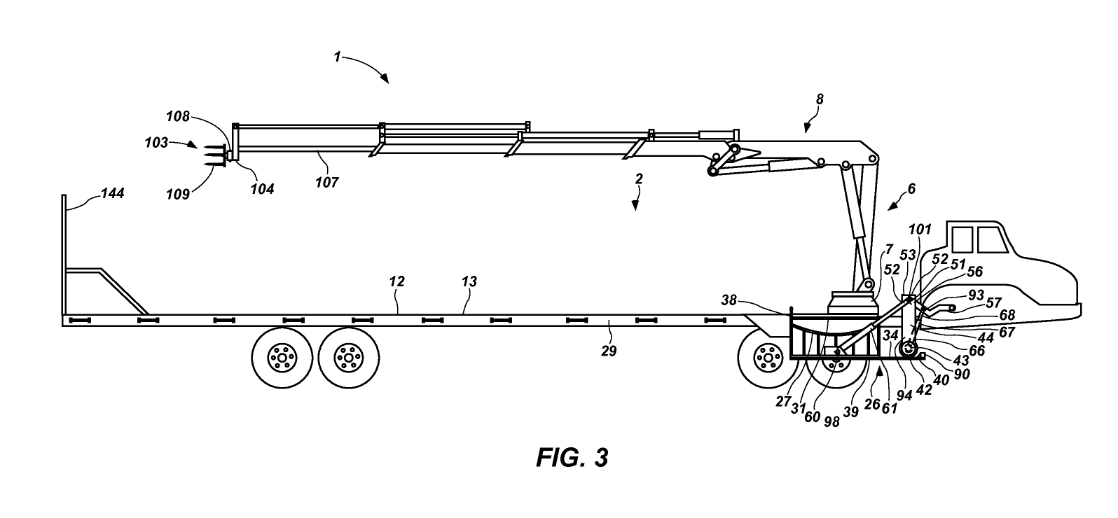

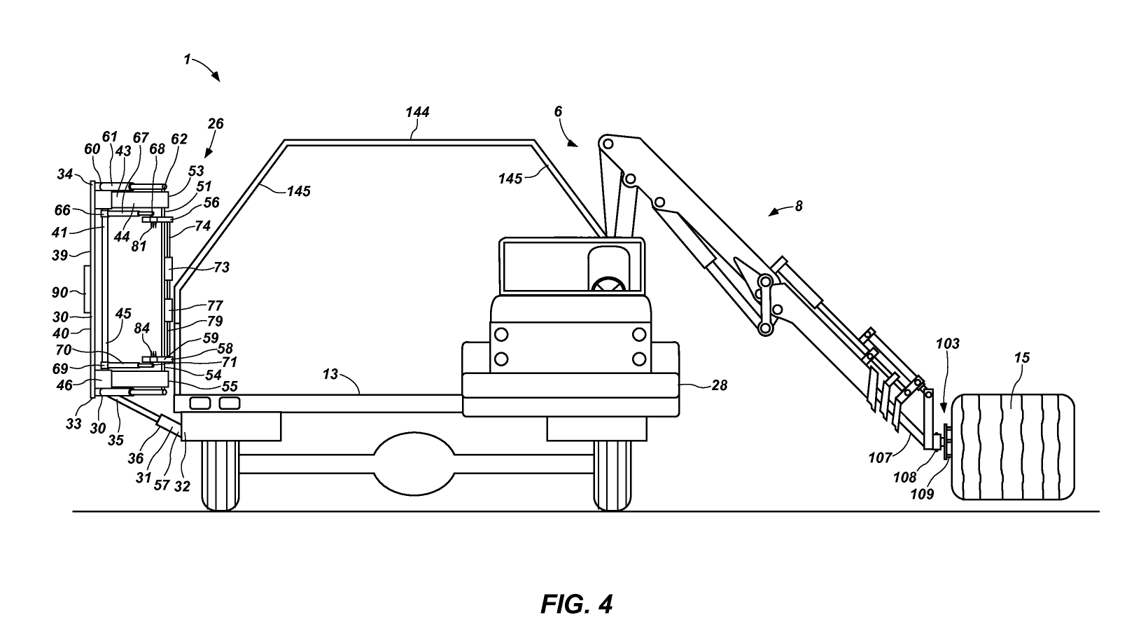

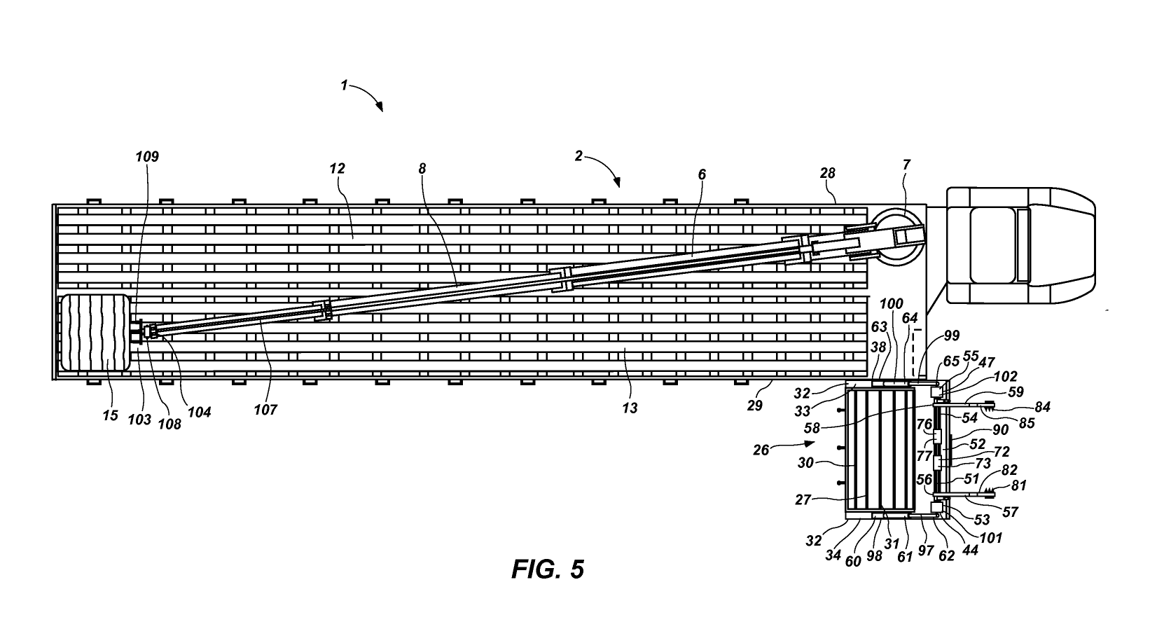

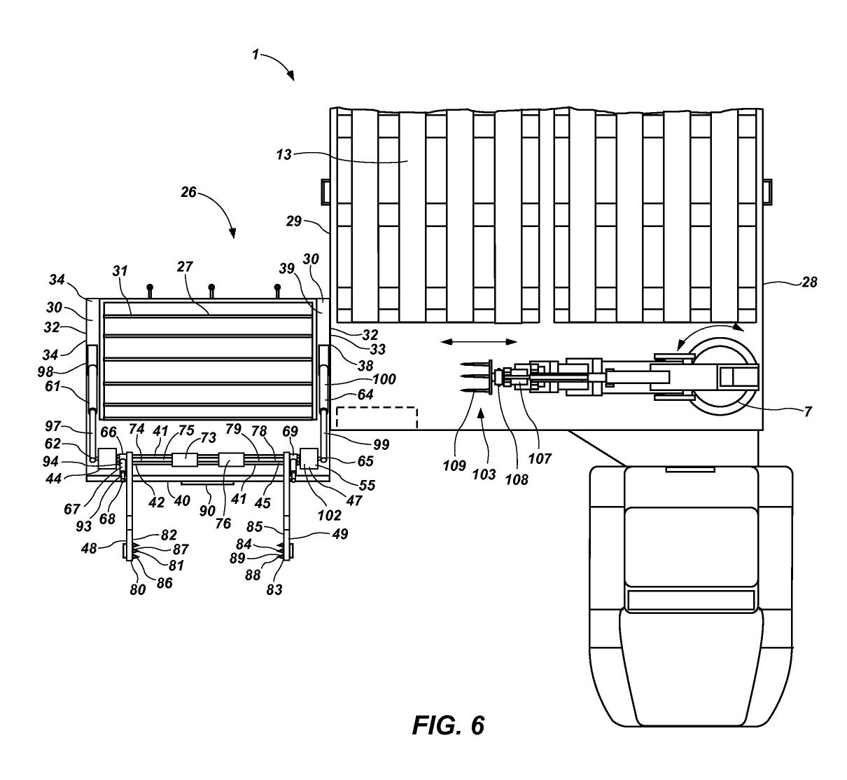

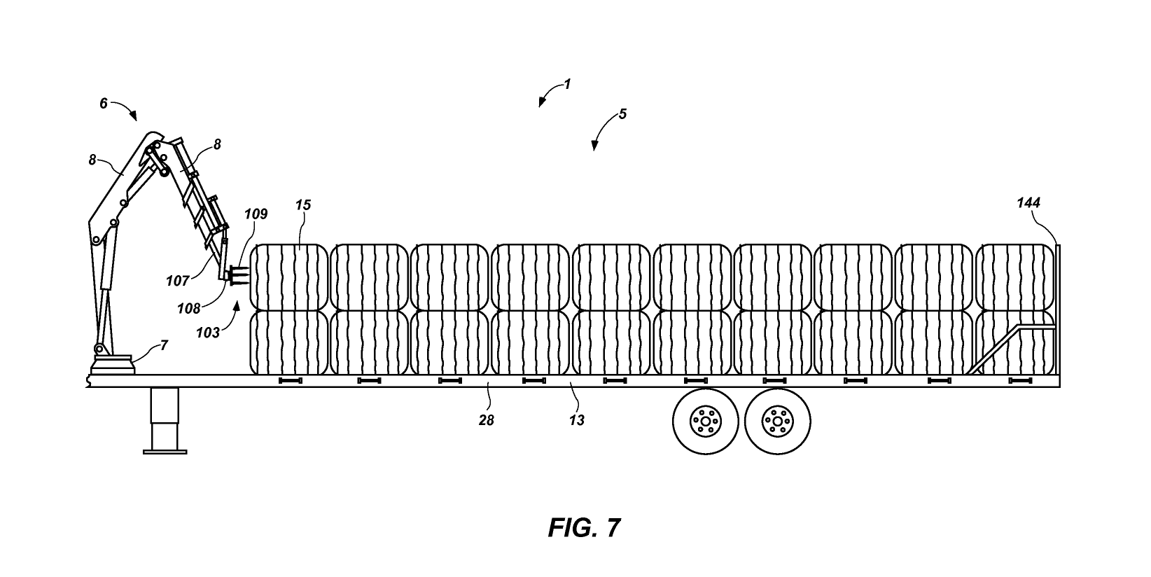

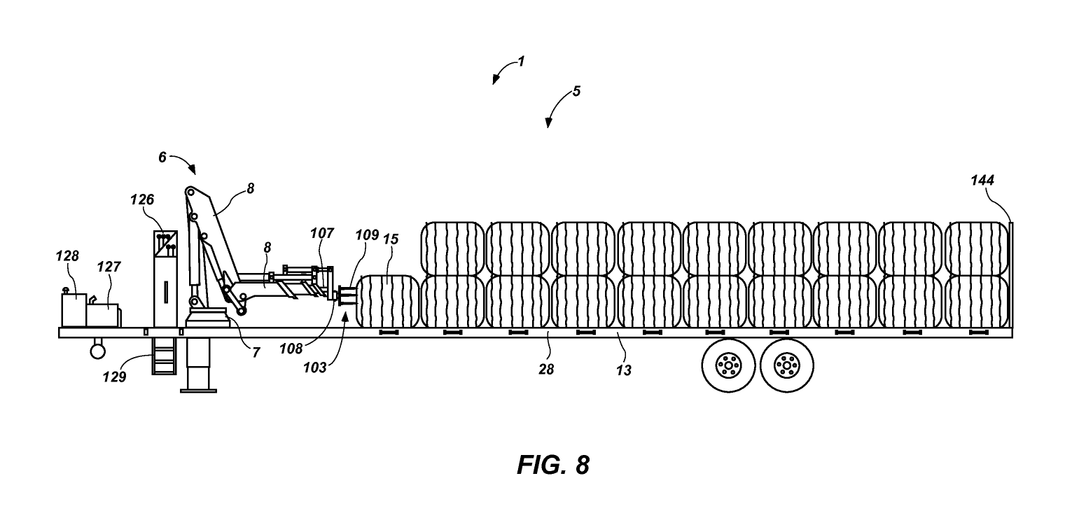

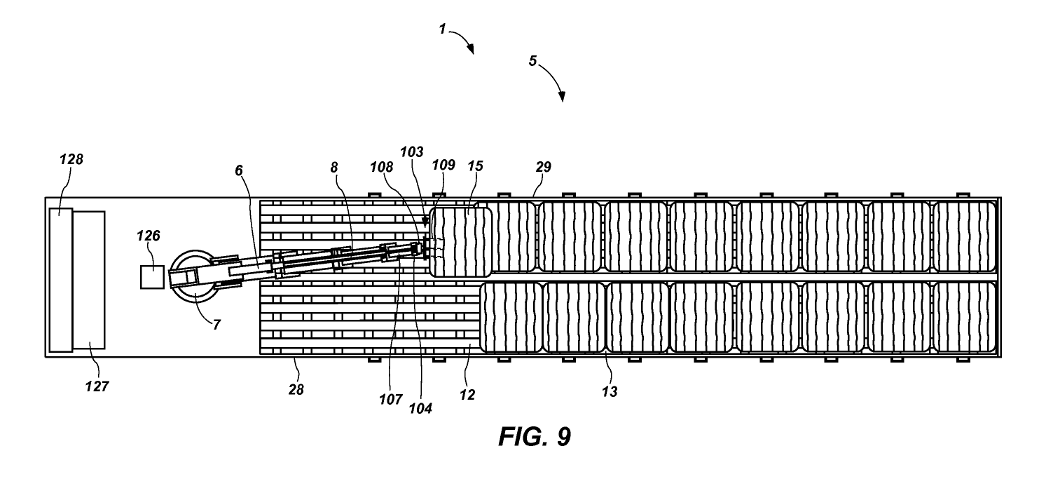

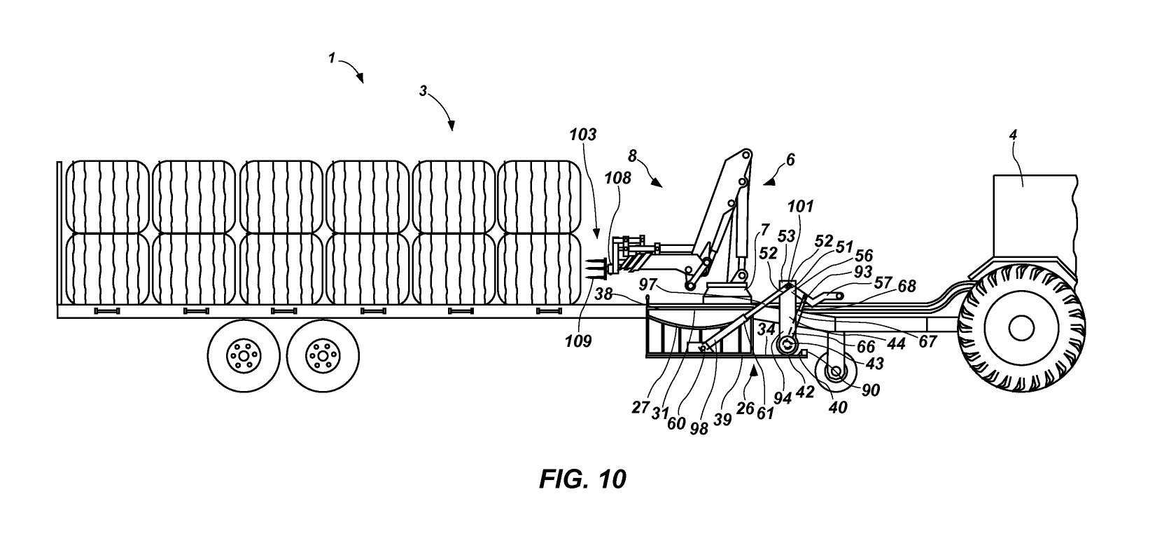

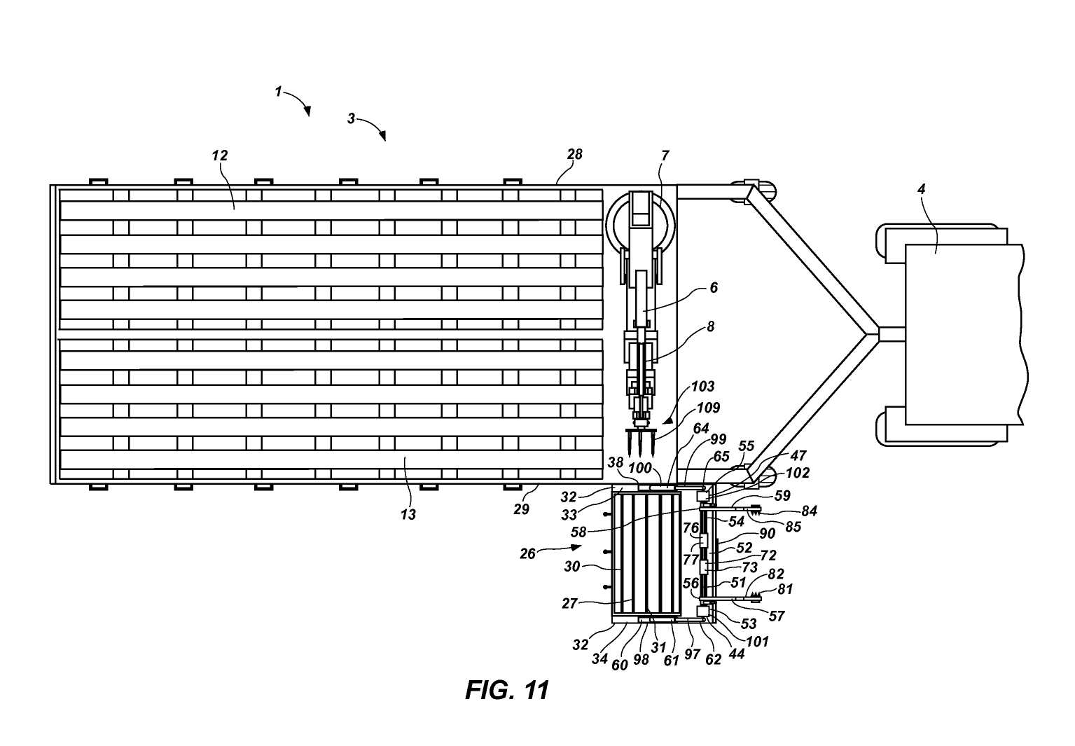

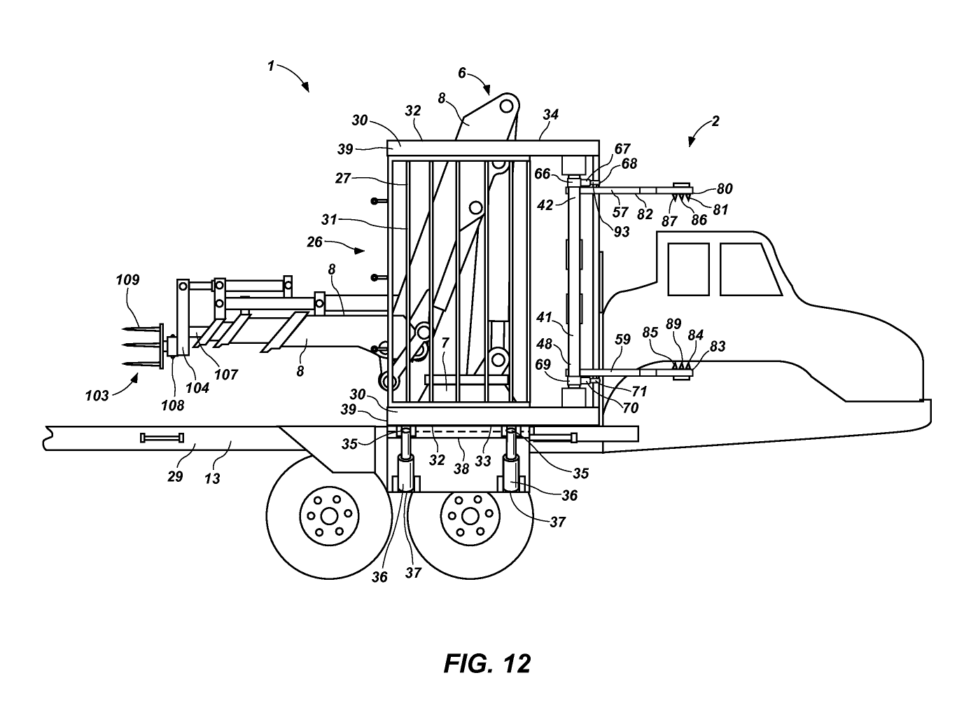

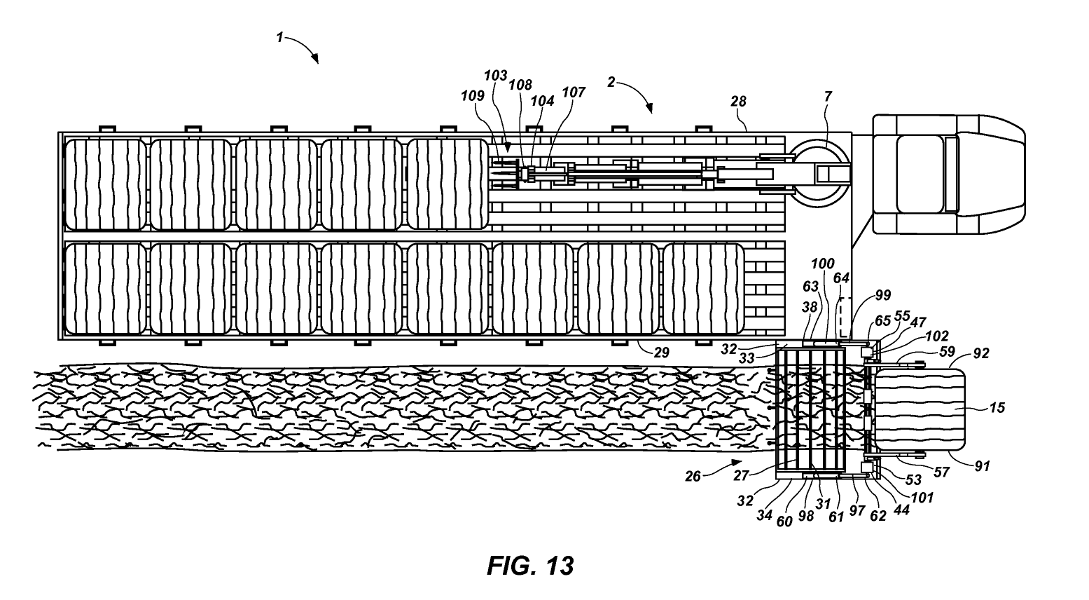

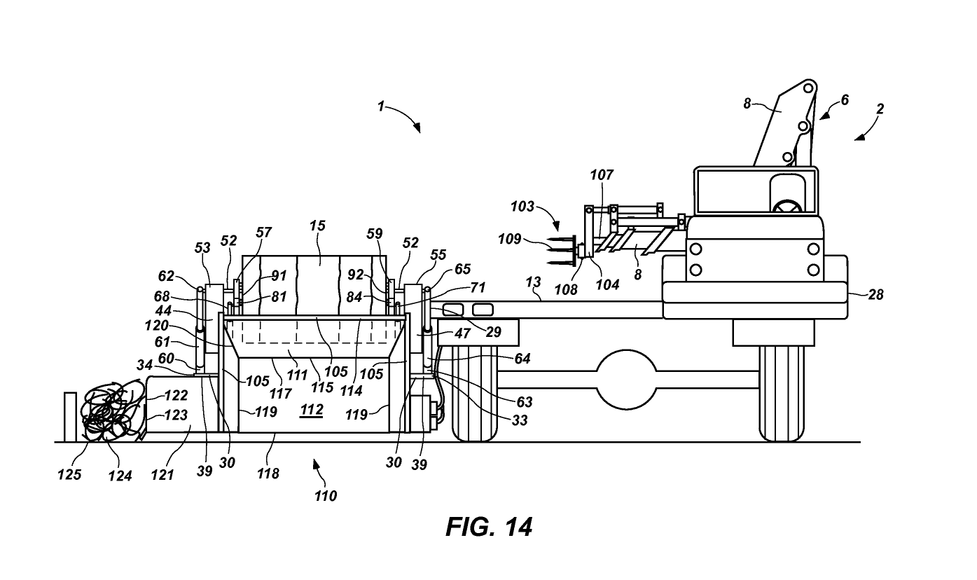

Three primary embodiments exist of the Bale Handler for round bales 1: a self-propelled bale handler 2, shown primarily in FIGS. 1 through 6 and 12 through 14; a tractor-pulled bale handler 3 which is pulled by a traditional tractor 4, as illustrated principally in FIGS. 10 and 11; and a semi-trailer bale handler 5, portrayed predominantly in FIGS. 7 through 9 and 22, which is pulled by the traditional type of powered truck, often termed a road tractor, known in the art to pull semi-trailer tractors. Herein the term “vehicle” shall include both a self-propelled vehicle and a vehicle not having its own propulsion, such as a traditional trailer.

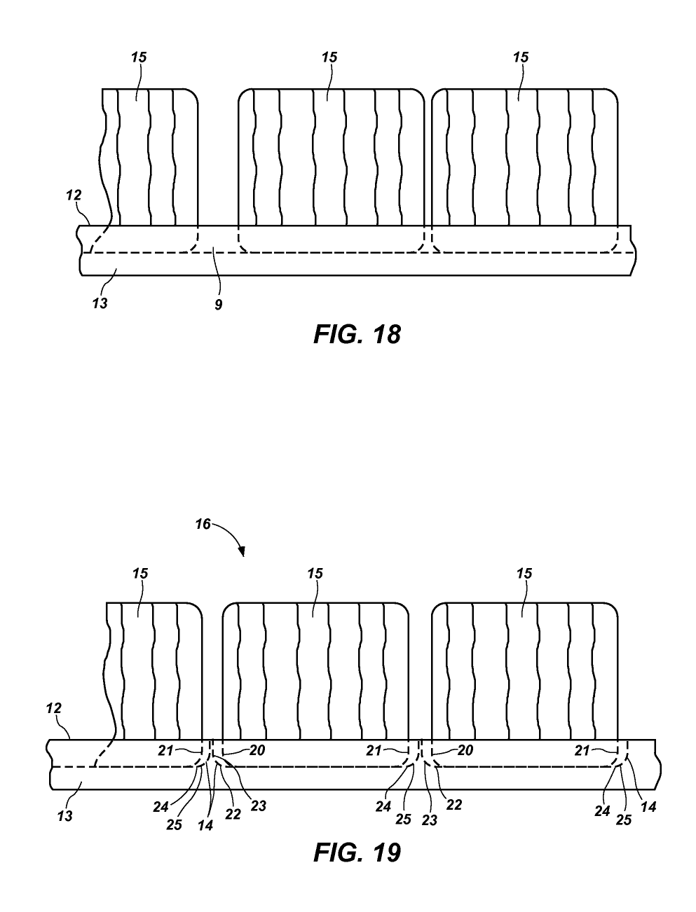

The semi-trailer bale handler 5 comprises any crane 6 known in the art which can rotate about its base 7 and extend its boom 8 to at least one storage tub 9 and, preferably, two laterally adjacent storage tubs 9. Each storage tub 9 has sloped sides 10, 11 (being either an angled plane or a curve) and, preferably, in a first embodiment, illustrated in part in FIG. 18, extends substantially the full longitudinal length of the storage area 12 on the bed 13 of the bale handler 5. Preferably, however, individual storage tubs 14, shown in FIG. 19, are provided to accommodate each bale 15, there being at least one column 16 and, preferably, two laterally adjacent columns 16 of individual storage tubs 14. The boom 8 of the crane 6 is selected to be sufficiently long to place a bale 15 anywhere in such storage tubs 9 or in any individual storage tub 14, when individual storage tubs 14 are employed.

The dimensions of each storage tub 9 are selected so as to accommodate the bales 15 intended to be carried by the tubs 9. Preferably, the sloped sides 10, 11 are portions of a curve 17 running continuously transversely across each storage tub 9. And, preferably, the lowest point 18 of such curve 17 is substantially at the transverse center 19 of the tub 9, especially when such lowest point 18 provides some of the support for a bale 15 or bales 15. The critical feature of the sloped sides 10, 11 is that the slope and dimensions of such sloped sides 10, 11 are such that the lowest point of a bale 15 placed between and supported by such sloped sides 10, 11 will be substantially at the transverse center 19 of the tub 9.

For individual storage tubs 14 both the forward end 20 and the rear end 21 are sloped, preferably curved. Moreover, preferably, the individual storage tubs 14 are of such dimensions that the distance between the bottom 22 of the front curve 23 and the bottom 24 of the rear curve 25 is substantially equal to the length of the bales 15 intended to be carried by the individual storage tubs 14. This causes the location of a bale 15 to be precisely known even if the initial placement of the bale 15 was not so accurate. Such precision facilitates, as discussed below, automation of the loading and unloading process.

The bed 13 can be either a traditional truck bed or a traditional framework for supporting the storage tubs 9 or individual storage tubs 14.

Of the embodiments for the Bale Handler 1 the semi-trailer bale handler 5 employs a crane 6 while the self-propelled bale handler 2 and the tractor-pulled bale handler 3 preferably utilize a crane 6. The semi-trailer bale handler 5 has one or more storage tubs 9 or, preferably, one or more individual storage tubs 14, such storage tubs 9 or individual storage tubs 14 being optional but preferred for the self-propelled bale handler 2 and the tractor-pulled bale handler 3; but only the self-propelled bale handler 2 and the tractor-pulled bale handler 3 have a lifting arm mechanism 26.

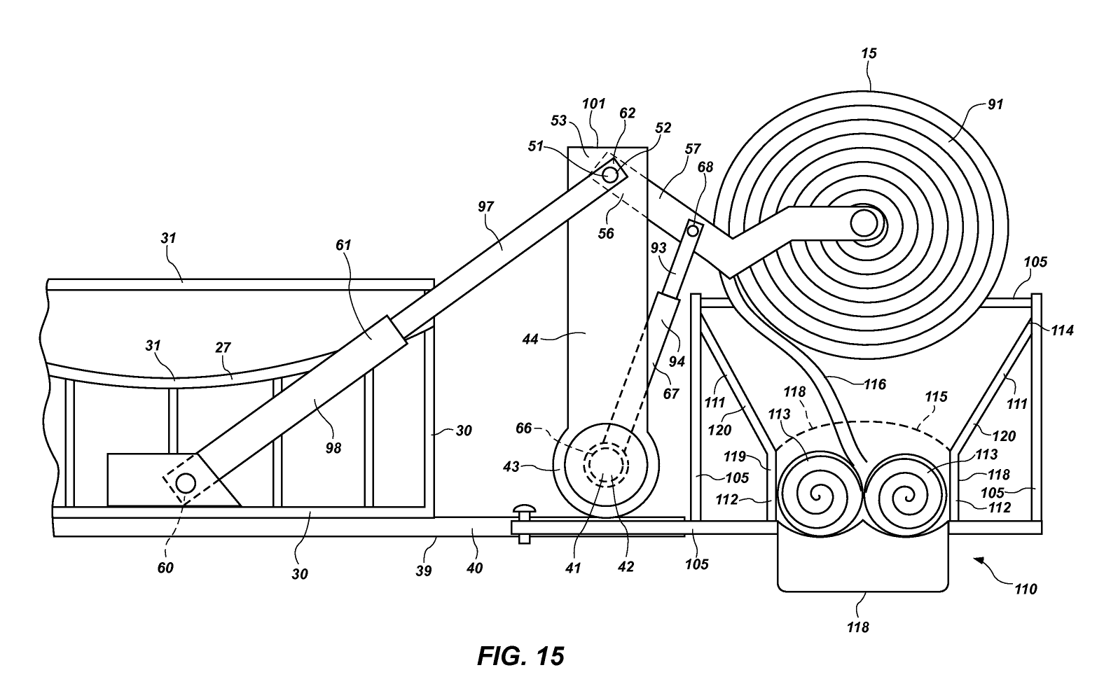

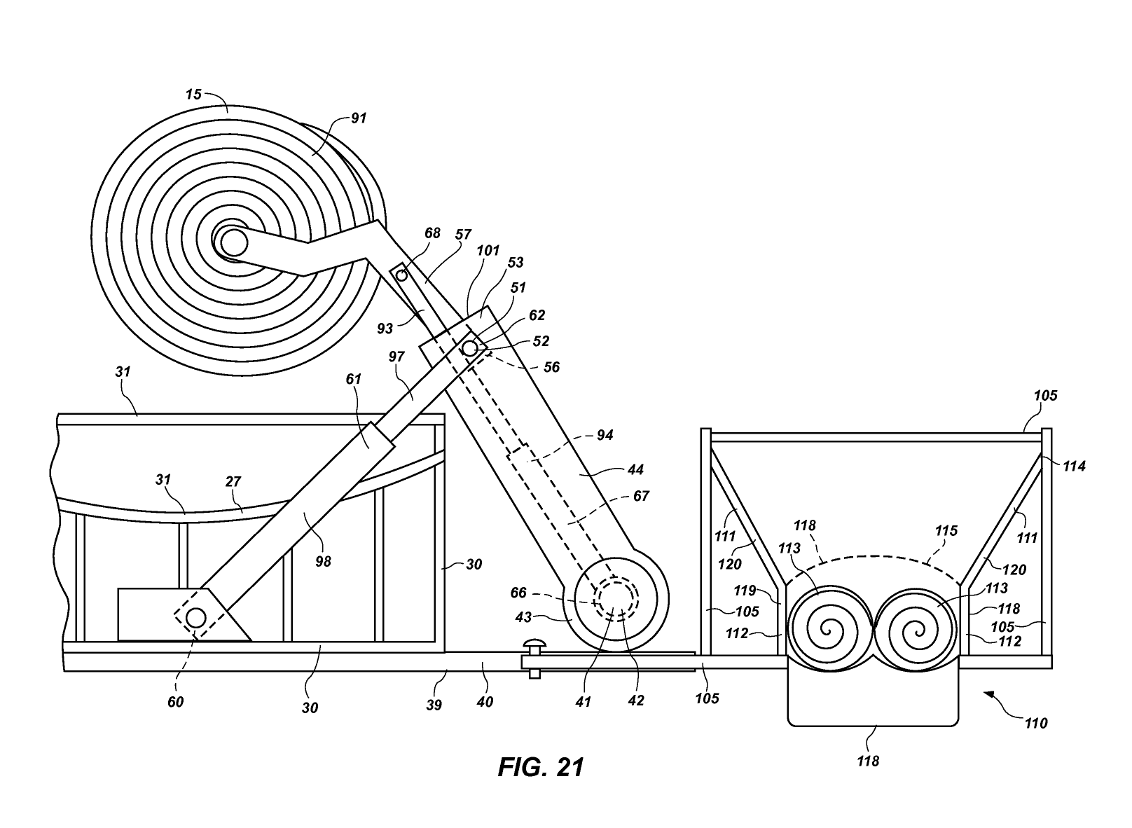

The lifting arm mechanism 26, shown with the greatest detail in FIGS. 15 and 21, can be constructed in any manner known to one of ordinary skill in the art such that the mechanism 26 can grasp a bale 15 on the ground; lift such bale 15 to a transitional platform 27 of the bale handler 2, 3; release the bale 15 on the transitional platform 27 for the crane 6 to move; grasp a bale 15 located on the transitional platform 27; lift such bale 15 away from the transitional platform 27 until it is suspended over, or touching, the ground; and, preferably, unroll the bale 15. The transitional platform 27 is either part of the bed 13 of the bale handler 2, 3 or is either directly or indirectly attached to the bed 13 of the bale handler 2, 3. Therefore, for this reason and because the transitional platform 27 at times holds a bale 15, for the purposes of this invention the term “bed” includes the transitional platform 27 whenever a transitional platform 27 is present.

Preferably, an individual storage tub 14 is located on the transitional platform 27 where the lifting arm mechanism 26 deposits a bale 15.

To facilitate storage for movement over roads, the lifting arm mechanism 26 is preferably rotatably attached to the bale handler 2, 3—on either the left side 28 or the right side 29 of the bale handler 2, 3.

The preferred embodiment for the lifting arm mechanism 26 comprises a mechanism support structure 30. The top 31 of the mechanism support structure 30 preferably comprises the transitional platform 27.

Near the top 31 of the mechanism support structure 30 and one of the sides 32 (left 33 or right 34) of the mechanism support structure 30, the mechanism support structure 30 is rotatably connected to the bed 13 of the bale handler 2, 3. To raise the lifting arm mechanism 26 for storage or to lower the lifting arm mechanism 26 for operation, a first end 35 of one or more hydraulic cylinders 36, designated the mechanism lifting cylinder or cylinders 36, is rotatably attached to the side 32 of the mechanism support structure 30 that is nearer the bale hander 2, 3; and a second end 37 of the one or more mechanism lifting cylinders 36 is rotatably attached to the bale handler 2, 3 below the position 38 at which the mechanism support structure 30 is rotatably connected to the bed 13 of the bale handler 2, 3.

Near the bottom 39 and the front 40 of the mechanism support structure 30 a lower axle 41 is attached to the mechanism support structure 30. Near a first end 42 of the lower axle 41 a lower end 43 of a right vertical support member 44 is rotatably attached to the lower axle 41; and near a second end 45 of the lower axle 41 a lower end 46 of a left vertical support member 47 is rotatably attached to the lower axle 41. A first end 51 of an upper axle 52 is rotatably connected to and extends through the right vertical support member 44 near an upper end 53 of the right vertical support member 44. A second end 54 of the upper axle 52 is rotatably connected to and preferably extends through the left vertical support member 47 near an upper end 55 of the left vertical support member 47.

A first end 56 of a first main lifting arm 57 is slidably attached to the upper axle 52 near the first end 51 of the upper axle 52 but farther from the first end 51 of the upper axle 52 than the right vertical support member 44. Similarly, a first end 58 of a second main lifting arm 59 is slidably attached to the upper axle 52 near the second end 54 of the upper axle 52 but farther from the second end 54 of the upper axle 52 than the left vertical support member 47.

A first end 60 of a primary hydraulic cylinder 61, designated the right primary hydraulic cylinder 61, is rotatably attached to the mechanism support structure 30 near the bottom 39 and on the right side 34 of the mechanism support structure 30. The second end 62 of the right primary hydraulic cylinder 61 is rotatably connected to the first end 51 of the upper axle 52. Preferably, a first end 63 of a second primary hydraulic cylinder 64, designated the left primary hydraulic cylinder 64, is similarly rotatably connected to the mechanism support structure 30 near the bottom 39 and on the left side 33 of the mechanism support structure 30. Also preferably, the second end 65 of the left primary hydraulic cylinder 64 is rotatably attached to the second end 54 of the upper axle 52.

A first end 66 of a secondary hydraulic cylinder 67, designated the right secondary hydraulic cylinder 67, is rotatably and slidably attached to the lower axle 41. The second end 68 of the right secondary hydraulic cylinder 67 is rotatably connected to the first main lifting arm 57. Preferably, a first end 69 of a second secondary hydraulic cylinder 70, designated the left secondary hydraulic cylinder 70 is similarly rotatably and slidably connected to the lower axle 41. Also preferably, the second end 71 of the left secondary hydraulic cylinder 70 is rotatably attached to the second main lifting arm 59.

A housing 72 of a first spreader hydraulic cylinder 73, designated the right spreader hydraulic cylinder 73, is attached to the upper axle 52 between the first main lifting arm 57 and the second main lifting arm 59. A free end 74 of the piston rod 75 of the right spreader hydraulic cylinder 73 is connected to the first main lifting arm 57. Similarly, a housing 76 of a second spreader hydraulic cylinder 77, designated the left spreader hydraulic cylinder 77, is connected to the upper axle 52 between the right spreader hydraulic cylinder 73 and the second main lifting arm 59. A free end 78 of the piston rod 79, of the left spreader hydraulic cylinder 77 is connected to the second main lifting arm 59.

A first end 80 of a first bale gripper 81 is attached to the left side 82 of the first main lifting arm 57 near the second end 48 of the first main lifting arm 57. Similarly, a first end 83 of a second bale gripper 84 is attached to the right side 85 of the second main lifting arm 59 near the second end 49 of the second main lifting arm 59. Projections 86 are located on the second end 87 of the first bale gripper 81, and projections 88 are also located on the second end 89 of the second bale gripper 84. Both bale grippers 81, 84 are preferably rotatable; and at least one of the bale grippers 81, 84 is, using any technology known in the art, preferably motorized.

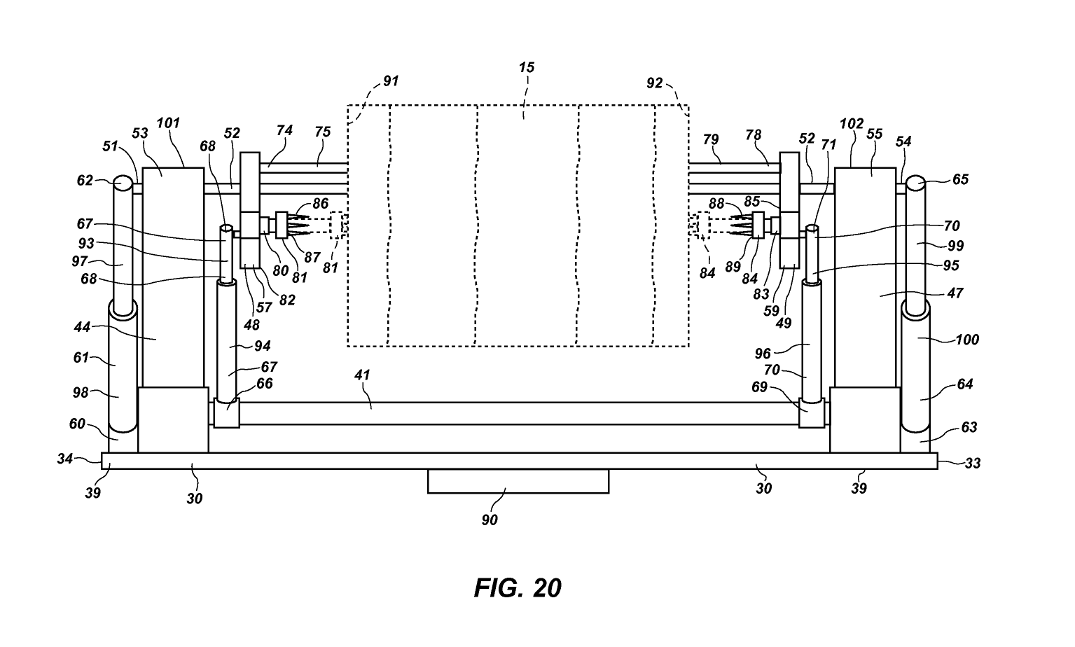

Optionally, rather than having the attachment of the main lifting arms 57, 59 to the upper axle 52 be slidable and requiring the spreader hydraulic cylinders 73, 77, at least one, and preferably both, of the bale grippers 81, 84 can be, as illustrated in FIG. 20, telescoping, using any technology known in the art, such as a hydraulic cylinder or a motorized rotating screw working against threads within a channel inside a bale gripper 81, 84.

In operation, when either an operator observes or a proximity indicator 90 (which can be any such device that is known by one of ordinary skill in the art, such as—but not necessarily limited to—a contact switch or an ultrasonic detector) attached to the front 40, preferably on either side 33, 34 or between such sides 33, 34 of, the mechanism support structure 30, indicates that a bale 15 is in position to be grasped and raised by the lifting arm mechanism 26, the operator, using any technology known in the art, causes the spreader hydraulic cylinders 73, 77 to force the main lifting arms 57, 59 to move closer to each other, pulling the bale grippers 81, 84 closer together and their projections 86, 88 into the first end 91 and the second end 92, respectively, of the bale 15 (or, optionally, activates the telescoping of the bale grippers 81, 84 toward one another in lieu of using spreader hydraulic cylinders 73, 77 in order to accomplish the preceding).

Then the piston rod 93 of the right secondary hydraulic cylinder 67 is extended from the housing 94 of the right secondary hydraulic cylinder (and when the preferable left secondary hydraulic cylinder 70 is present, the piston rod 95 of the left secondary hydraulic cylinder 70 is extended from the housing 96 of the left secondary hydraulic cylinder 70) to raise the main lifting arms 57, 59 and thereby, the bale 15, as portrayed in FIG. 21.

Also, as further shown in FIG. 21, the piston rod 97 of the right primary hydraulic cylinder 61 is drawn into the housing 98 of the right primary hydraulic cylinder 61 (and when the preferable left primary hydraulic cylinder 64 is utilized, the piston rod 99 of the left primary hydraulic cylinder 64 is drawn into the housing 100 of the left primary hydraulic cylinder 64), thereby tilting the upper axle 52 and the top 101 of the right vertical support member 44 as well as the top 102 of the left vertical support member 47 toward the transitional platform 27.

These combined operations place the bale 15 on the transitional platform 27 (and when the individual storage tub 14 is preferably located on the transitional platform 27, into the individual storage tub 14).

Reversing these operations enables a bale 15 of hay to be retrieved from the transitional platform 27 (and, preferably, the individual storage tub 14 on the transitional platform 27) and either lowered to the ground or suspended above the ground for unrolling, preferably by rotating the bale grippers 81, 84. Of course when the bale 15 touches the ground, lateral movement of the bale handler 2, 3 will unroll a bale 15 because such lateral movement will cause the bale grippers 81, 84 to rotate when such bale grippers 81, 84 are, indeed, rotatable.

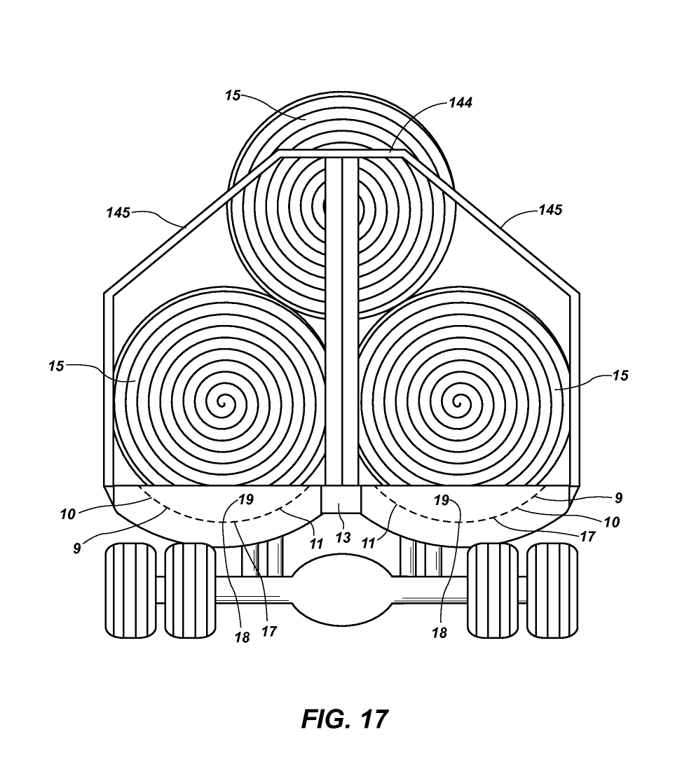

Of course, the crane 6, when it is preferably employed on the self-propelled bale handler 2 and the tractor-pulled bale handler 3, moves bales 15 to and from locations (preferably, storage tubs 9 and, even more preferably individual storage tubs 14) on the bed 13, including the transitional platform 27, of the self-propelled bale handler 2 and the tractor-pulled bale handler 3 and, when there are two or more laterally adjacent storage tubs 9 or two or more laterally adjacent columns 16 of individual storage tubs 14, on (as well as between, creating a triangular shape of bales 15 when there are two laterally adjacent storage tubs 9 or two laterally adjacent columns 16 of individual storage tubs 14, which triangular shape is most clearly evident in FIG. 17) and from previously placed laterally adjacent bales 15, as seen in FIG. 7. Moreover, if desired, the crane 6, when employed, can be used to load and unload any embodiment of the bale handler 5.

The preceding can be automated using technology that is well known in the art, such as that of U.S. Pat. Nos. 4,952,111; 7,419,345; 7,481,612; and 8,112,202, for grasping a bale 15 on the ground, moving the bale 15 to the transitional platform 27, and releasing the bale 15 on the transitional platform 27 and such as that of U.S. Pat. Nos. 4,091,943 and 6,074,155 for using the crane 6 to move a bale 15 from the transitional platform 27 to a storage tub 9 (preferably, an individual storage tub 14) or on top of bales 15 already in the storage tubs 9 (preferably, individual storage tubs 14), to return such a bale 15 to the transitional platform 27, to remove a bale 15 from a storage tub 9 (preferably, an individual storage tub 14) and place such bale 15 on the ground or an other intended storage place away from the bale handler 1, and to take a bale 15 from the ground or other intended storage place and move the bale 15 to a storage tub 9 (preferably, an individual storage tub 14) or on top of bales 15 already in the storage tubs 9 (preferably, individual storage tubs 14). One of ordinary skill in the art should, moreover, be capable of adapting the automation technology of U.S. Pat. Nos. 4,952,111; 7,419,345; 7,481,612; and 8,112,202 to enable the lifting arm mechanism 26 of the present invention to grasp a bale 15 located on the transitional platform 27; lift such bale 15 away from the transitional platform 27 until it is suspended over, or touching, the ground; and, preferably, unroll the bale 15.

As mentioned above, the cargo holding device 103 is preferably attached to the distal end 104 of the crane 6 and is rotatable in both the pitch plane, i.e., the plane containing the boom 8 of the crane 6, and the yaw plane, i.e., a plane that is perpendicular to the pitch plane and that contains the last segment 107 of the boom 8 of the crane 6, in a manner that is well known in the art, such as the cargo holding devices of the cranes of international publication number WO 87/01684 and U.S. Pat. No. 4,552,501. And even more preferably, such cargo holding device 103 comprises a base 108 from which one or more forks 109 project in order to pierce an end 91, 92 of a bale 15.

Using any memory and communication system known in the art, the location of the bales 15 can be stored on the bale handler 1 or at the storage location so that the location can be automatically provided to another bale handler 1 to facilitate the automatic removal of one or more bales 15 and the loading of such bales 15 on the other bale handler 1.

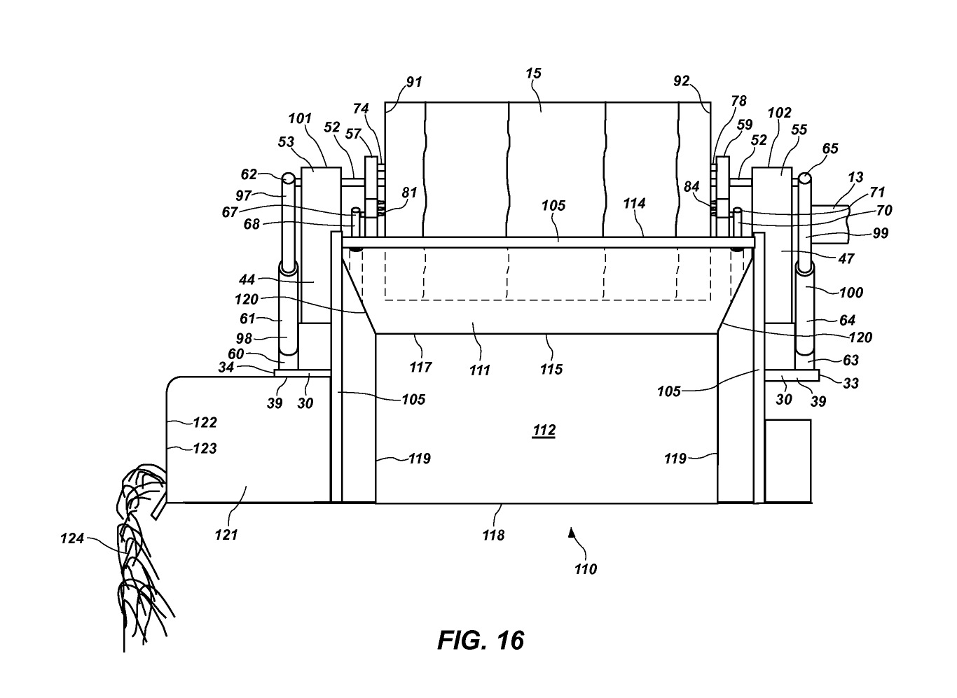

Optionally, an auger assembly 110, illustrated in FIGS. 15 and 16, comprises an auger assembly support structure 105, which is connected (preferably, releasably connected) to the mechanism support structure 30, preferably, to the front 40 and bottom 39 of the mechanism support structure and which, as its name suggests, supports the remainder of the auger assembly 110, such remainder comprising a feeder box 111, an auger housing 112, and an auger 113 within the auger housing 112.

The feeder box 111 has an open top 114 and bottom 115 to receive hay 116 unrolling from a bale 15 and to provide access for such unrolled hay 116 to the auger 113 within the auger housing 112 that is located below the feeder box 111. The auger housing 112 has an open top 117, a closed bottom 118, and sides 119 attached to the sides 120 of the feeder box 111. Preferably, a channel 121 leads from the auger 113 to an aperture 122, on the side 123 of the auger housing 112 opposite to the bale handler 2, 3 for discharging the particles of hay 124 produced by the auger 113 to the ground or a feed bunk 125.

Because the semi-trailer bale handler 5 may be required to load and unload bales 15 in the absence of a road tractor, the semi-trailer handler 5 has equipment not found on the self-propelled bale handler 2 and the tractor-pulled bale handler 3. A control panel 126 for the crane 6 is located on the bed 13 of the semi-trailer bale handler 5 along with a combined hydraulic fuel tank and hydraulic pump 127 to power the crane 6 and a combined diesel fuel tank and diesel engine 128 to power the hydraulic pump of the combined hydraulic fuel tank and hydraulic pump 127. And a ladder 129 attached to a side 28, 29 of the semi-trailer bale handler 5 to provide an operator access to the bed 13 of the semi-trailer bale handler 5.

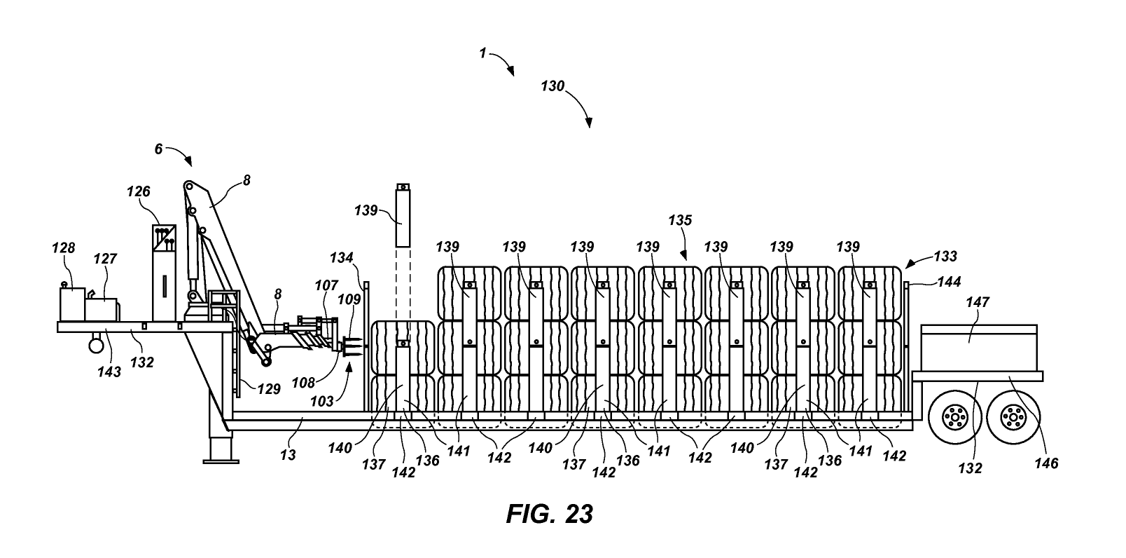

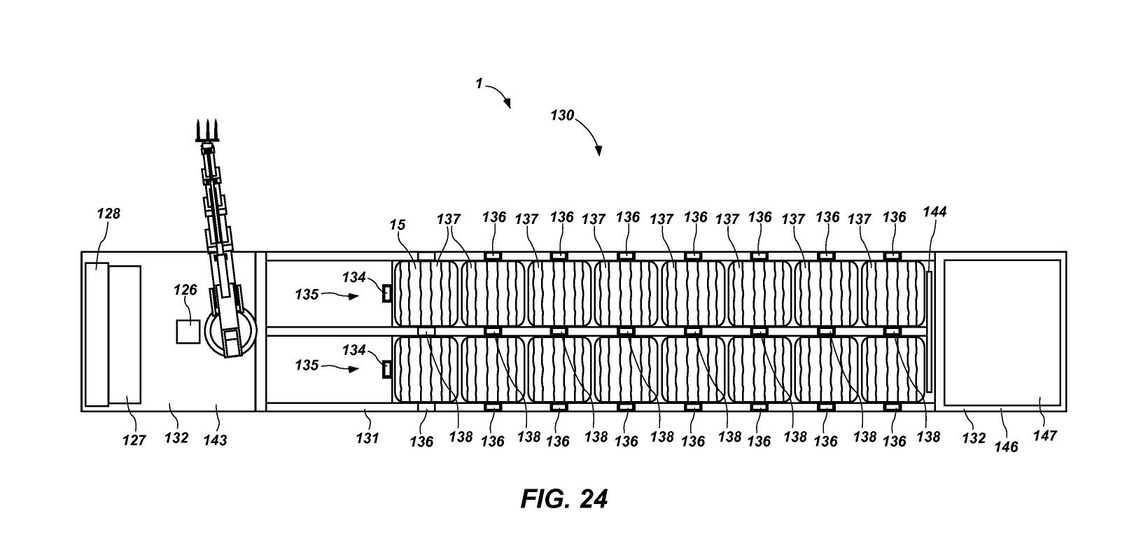

And in addition to the preceding embodiments of the bale handler 1, there is a specialized semi-trailer bale handler 130 termed a “drop-bed semi-trailer bale handler”, which is portrayed in FIGS. 23, 24, and 25.

As its name implies, the bale-carrying portion 131 of the bed 13 for the drop-bed semi-trailer bale handler 130 is lower than the remainder 132 of such bed 13 in order to accommodate an additional level 133 of bales 15.

Furthermore, for the drop-bed semi-trailer bale handler 130 the bales 15 are stacked directly on top of one another, rather than in the pyramid fashion of the other embodiments, when such other embodiments have laterally adjacent storage tubs 9 or individual storage tubs 14. To stabilize bales 15 stacked in this fashion a front brace post 134 is placed in front of each of the two columns 135 of bales 15, a side brace post 136 is placed at each side of each row 137 of individual storage tubs 14, and a middle brace post 138 is placed between laterally adjacent individual storage tubs 14. The two front brace posts 134, all the side brace posts 136, and all the middle brace posts 138 comprise an upper post element 139 removably attached utilizing any technique known in the art, preferably with a traditional pin in traditional apertures, to a lower post element 140. The lower end 141 of each lower post element 140 fits removably into an aperture 142 in the bed 13 of the drop-bed semi-trailer bale handler 130.

Because of the proximity to the ground for the bale-carrying portion 131 of the bed 13 for the drop-bed semi-trailer bale handler 130 and the distance between that portion 131 and the portion 143 of the bed 13 having the control panel 126, the ladder 129 on the drop-bed semi-trailer bale handler 130 provides access from the bale-carrying portion 131 of the bed 13 to the portion 143 of the bed 13 having the control panel 126, rather than from the ground to the bed 13 as is the case for the semi-trailer bale handler 5.

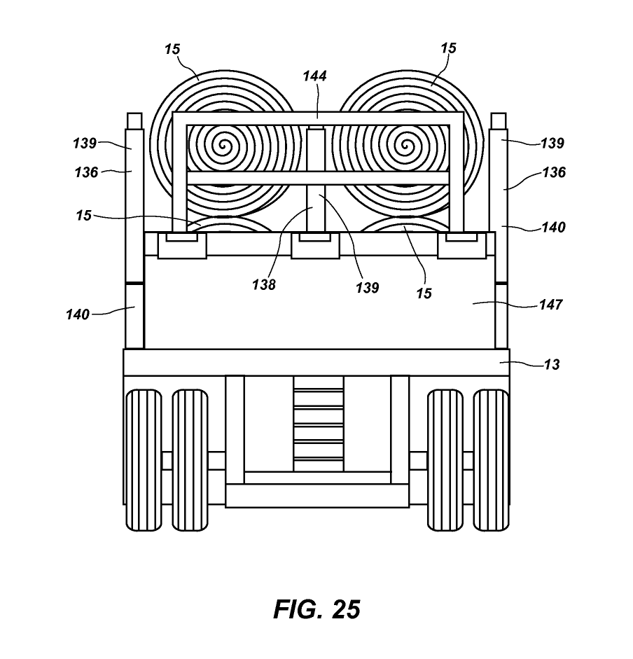

Similarly, because of the different shapes for the stacks of bales 15, the rear post frame 144 for the drop-bed semi-trailer bale handler 130 has, as seen in FIG. 25, a rectangular shape rather than having the sloped upper corners 145 which the rear post frame 144 for all the other embodiments of the Bale Handler 1 has, as shown in FIG. 17.

And the rear portion 146 of the bed 13 for the drop-bed semi-trailer bale handler 130 holds a container 147 for the posts 134, 136, 138 and the traditional pins or other traditional connectors for the upper post elements 139 and the lower post elements 140.

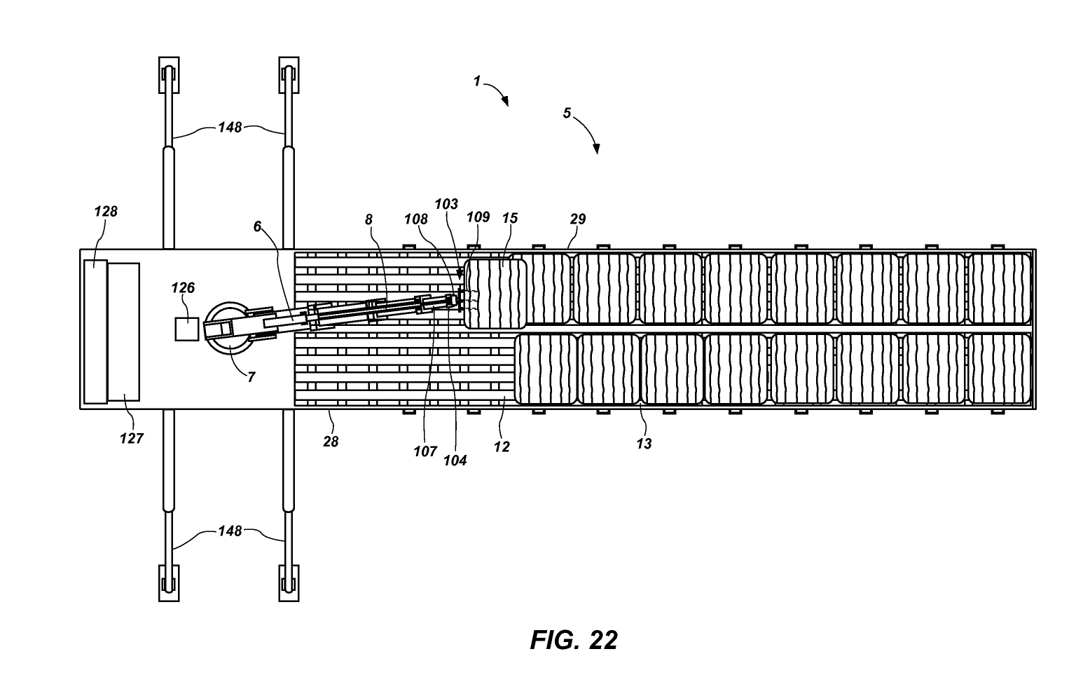

Optionally, the semi-trailer bale handler 5 can for increased stability, when loading or unloading bales 15, extend, as illustrated in FIG. 22, one or more outriggers 148 from each side 28, 29 of the semi-trailer bale handler 5.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

I claim:

1. A bale handler for round bales, which comprises:
a vehicle having a bed with a storage area;
a first storage tub in the storage area on the bed of said vehicle, said storage tub having sloped sides of such slope and dimensions as to accommodate round bales of hay with the lowest point of each bale being at the transverse center of said tub; and
a crane on the bed outside the storage area, said crane being able to extend its boom to place a bale of hay anywhere in said first storage tub.

2. The bale handler for round bales as recited in claim 1, further comprising:
at least one additional storage tub laterally adjacent to said first storage tub in the storage area on the bed of said vehicle, each of said additional storage tubs having sloped sides of such slope and dimensions as to accommodate bales of hay with the lowest point of each bale being substantially at the transverse center of said tub; and
wherein said crane is also able to extend its boom to place a bale of hay anywhere in any of said additional laterally adjacent storage tubs.

3. A bale handler for round bales, which comprises:
a vehicle having a bed with a storage area;
a first column of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
a crane on the bed outside the storage area, said crane being able to extend its boom to place a bale of hay in any of the individual storage tubs.

4. The bale handler for round bales as recited in claim 3, further comprising:
at least one additional column of individual storage tubs in the storage area on the bed of said vehicle laterally adjacent to said first column of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay in any of the additional individual storage tubs.

5. A bale handler for round bales, which comprises:
a vehicle having a bed with a storage area; and
a means for grasping a bale on the ground, lifting the bale to a transitional platform, releasing the bale on the transitional platform, grasping a bale located on a transitional platform, and lifting the bale away from the transitional platform until the bale is suspended over or touching the ground.

6. The bale handler for round bales as recited in claim 5, further comprising:
a crane on the bed outside the storage area, said crane being able to extend its boom to place a bale of hay in the storage area of the bed.

7. The bale handler for round bales as recited in claim 6, further comprising:
a first storage tub in the storage area on the bed of said vehicle, said storage tub having sloped sides of such slope and dimensions as to accommodate round bales of hay with the lowest point of each bale being at the transverse center of said tub; and
wherein the crane is able to extend its boom to place a bale of hay in said first storage tub.

8. The bale handler for round bales as recited in claim 7, further comprising:
at least one additional storage tub laterally adjacent to said first storage tub, each of said additional storage tubs having sloped sides of such slope and dimensions as to accommodate bales of hay with the lowest point of each bale being substantially at the transverse center of said tub; and
wherein said crane is also able to extend its boom to place a bale of hay in any of said additional laterally adjacent storage tubs.

9. The bale handler for round bales as recited in claim 6, further comprising:
a first column of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
wherein the crane on the bed outside the storage area is able to extend its boom to place a bale of hay in any of the individual storage tubs.

10. The bale handler for round bales as recited in claim 9, further comprising:
at least one additional column of individual storage tubs in the storage area on the bed of said vehicle laterally adjacent to said first column of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the additional individual storage tubs.

11. The bale handler for round bales as recited in claim 5, further comprising:
a means for unrolling a round bale of hay.

12. The bale handler for round bales as recited in claim 11, further comprising:
a crane on the bed outside the storage area, said crane being able to extend its boom to place a bale of hay in the storage area of the bed.

13. The bale handler for round bales as recited in claim 12, further comprising:
a first storage tub in the storage area on the bed of said vehicle, said storage tub having sloped sides of such slope and dimensions as to accommodate round bales of hay with the lowest point of each bale being at the transverse center of said tub; and
wherein the crane is able to extend its boom to place a bale of hay in said first storage tub.

14. The bale handler for round bales as recited in claim 13, further comprising:
at least one additional storage tub laterally adjacent to said first storage tub, each of said additional storage tubs having sloped sides of such slope and dimensions as to accommodate bales of hay with the lowest point of each bale being substantially at the transverse center of said tub; and
wherein said crane is also able to extend its boom to place a bale of hay in any of said additional laterally adjacent storage tubs.

15. The bale handler for round bales as recited in claim 12, further comprising:
a first column of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
wherein the crane on the bed outside the storage area is able to extend its boom to place a bale of hay in any of the individual storage tubs.

16. The bale handler for round bales as recited in claim 15, further comprising:
at least one additional column of individual storage tubs in the storage area on the bed of said vehicle laterally adjacent to said first column of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the additional individual storage tubs.

17. The bale handler for round bales as recited in claim 11, further comprising:
an auger assembly attached to the bed of the bale handler so as to receive unrolled hay from said means for unrolling a round bale of hay to enable the auger assembly to produce and discharge particles of hay.

18. The bale handler for round bales as recited in claim 17, further comprising:
a crane on the bed outside the storage area, said crane being able to extend its boom to place a bale of hay in the storage area of the bed.

19. The bale handler for round bales as recited in claim 18, further comprising:
a first storage tub in the storage area on the bed of said vehicle, said storage tub having sloped sides of such slope and dimensions as to accommodate round bales of hay with the lowest point of each bale being at the transverse center of said tub; and
wherein the crane is able to extend its boom to place a bale of hay in said first storage tub.

20. The bale handler for round bales as recited in claim 19, further comprising:
at least one additional storage tub laterally adjacent to said first storage tub, each of said additional storage tubs having sloped sides of such slope and dimensions as to accommodate bales of hay with the lowest point of each bale being substantially at the transverse center of said tub; and
wherein said crane is also able to extend its boom to place a bale of hay in any of said additional laterally adjacent storage tubs.

21. The bale handler for round bales as recited in claim 18, further comprising:
a first column of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
wherein the crane on the bed outside the storage area is able to extend its boom to place a bale of hay in any of the individual storage tubs.

22. The bale handler for round bales as recited in claim 21, further comprising:
at least one additional column of individual storage tubs in the storage area on the bed of said vehicle laterally adjacent to said first column of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the additional individual storage tubs.

23. The bale handler for round bales a recited in claim 5, wherein the means for grasping, lifting, and releasing comprises:
a mechanism support structure having a top, a bottom, a front, a left side, and a right side with one of the sides, near the top of such side, rotatably connected to the bed of the said vehicle;
at least one mechanism lifting cylinder having a first end rotatably attached to the side of said mechanism support structure that is nearer the bed of the bale handler and having a second end rotatably attached to said vehicle below where said mechanism support structure is rotatably connected to the bed of said vehicle;
a lower axle having a first end and a second end, said lower axle being attached to said mechanism support structure near the bottom and the front of said mechanism support structure;
a right vertical support member having a lower end and an upper end with the lower end of said right vertical support member being rotatably attached so said lower axle near the first end of said lower axle;
a left vertical support member having a lower end and an upper end with the lower end of said left right vertical support member being rotatably attached to said lower axle near the second end of said lower axle;
an upper axle having a first end and a second end, the first end of said upper axle being rotatable connected to and extending through said right vertical support member near the upper end of said right vertical support member, and the second end of said upper axle being rotatably connected to and extending through said left vertical support member near the upper end of said left vertical support member;
a first main lifting arm having a left side, a first end, and a second end, the first end of said first main lifting arm being slidably attached to said upper axle near the first end of said upper axle but farther from the first end of said upper axle than where said right vertical support member is rotatably connected to said upper axle;
a second main lifting arm having a right side, a first end, and a second end, the first end of said second main lifting arm being slidably attached to said upper axle near the second end of said upper axle but farther from the second end of said upper axle than where said left vertical support member is rotatably connected to said upper axle;
a right primary hydraulic cylinder having a first end and a second end, the first end of said right primary hydraulic cylinder being rotatably attached to said mechanism support structure near the bottom and on the right side of said mechanism support structure, and the second end of said right primary hydraulic cylinder being rotatably connected to the first end of said upper axle;
a left primary hydraulic cylinder having a first end and a second end, the first end of said left primary hydraulic cylinder being rotatably connected to said mechanism support structure near the bottom and on the left side of said mechanism support structure, and the second end of said left primary hydraulic cylinder being rotatably connected to the second end of said upper axle;
a right secondary hydraulic cylinder having a first end and a second end, the first end of said right secondary hydraulic cylinder being rotatably and slidably attached to said lower axle, and the second end of said right secondary hydraulic cylinder being rotatably connected to said first main lifting arm;
a left secondary hydraulic cylinder having a first end and a second end, the first end of said left secondary hydraulic cylinder being rotatably and slidably attached to said lower axle, and the second end of said left secondary hydraulic cylinder being rotatably connected to said second main lifting arm;
a right spreader hydraulic cylinder having a housing attached to said upper axle between said first main lifting arm and said second main lifting arm, said right spreader hydraulic cylinder also having a piston with the piston having a free end connected to said first main lifting arm;
a left spreader hydraulic cylinder having a housing attached to said upper axle between said first main lifting arm and said second main lifting arm, said left spreader hydraulic cylinder also having a piston with the piston having a free end connected to said second main lifting arm;
a first rotatable gripper having a first end attached to the left side of said first main lifting arm near the first end of said first main lifting arm, said first rotatable gripper also having a second end with projections located on such second end projects; and
a second rotatable gripper having a first end attached to the right side of said second main lifting arm near the first end of said second main lifting arm, said second rotatable gripper also having a second end with projections located on such second end.

24. The bale handler for round bales as recited in claim 23, further comprising:
a crane on the bed outside the storage area, said crane being able to extend its boom to place a bale of hay in the storage area of the bed.

25. The bale handler for round bales as recited in claim 24, further comprising:
a first storage tub in the storage area on the bed of said vehicle, said storage tub having sloped sides of such slope and dimensions as to accommodate round bales of hay with the lowest point of each bale being at the transverse center of said tub; and
wherein the crane is able to extend its boom to place a bale of hay in said first storage tub.

26. The bale handler for round bales as recited in claim 25, further comprising:
at least one additional storage tub laterally adjacent to said first storage tub, each of said additional storage tubs having sloped sides of such slope and dimensions as to accommodate bales of hay with the lowest point of each bale being substantially at the transverse center of said tub; and
wherein said crane is also able to extend its boom to place a bale of hay in any of said additional laterally adjacent storage tubs.

27. The bale handler for round bales as recited in claim 24, further comprising:
a first column of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
wherein the crane on the bed outside the storage area is able to extend its boom to place a bale of hay in any of the individual storage tubs.

28. The bale handler for round bales as recited in claim 27, further comprising:
at least one additional column of individual storage tubs in the storage area on the bed of said vehicle laterally adjacent to said first column of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the additional individual storage tubs.

29. The bale handler for round bales as recited in claim 23, wherein:
at least one of the first rotatable gripper and the second rotatable gripper is motorized.

30. The bale handler for round bales as recited in claim 29, further comprising:
a crane on the bed outside the storage area, said crane being able to extend its boom to place a bale of hay in the storage area of the bed.

31. The bale handler for round bales as recited in claim 30, further comprising:
a first storage tub in the storage area on the bed of said vehicle, said storage tub having sloped sides of such slope and dimensions as to accommodate round bales of hay with the lowest point of each bale being at the transverse center of said tub; and
wherein the crane is able to extend its boom to place a bale of hay in said first storage tub.

32. The bale handler for round bales as recited in claim 31, further comprising:
at least one additional storage tub laterally adjacent to said first storage tub, each of said additional storage tubs having sloped sides of such slope and dimensions as to accommodate bales of hay with the lowest point of each bale being substantially at the transverse center of said tub; and
wherein said crane is also able to extend its boom to place a bale of hay in any of said additional laterally adjacent storage tubs.

33. The bale handler for round bales as recited in claim 30, further comprising:
a first column of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
wherein the crane on the bed outside the storage area is able to extend its boom to place a bale of hay in any of the individual storage tubs.

34. The bale handler for round bales as recited in claim 33, further comprising:
at least one additional column of individual storage tubs in the storage area on the bed of said vehicle laterally adjacent to said first column of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the additional individual storage tubs.

35. The bale handler for round bales as recited in claim 29, further comprising:
an auger assembly attached to the bed of the bale handler so as to receive unrolled hay from said means for unrolling a round bale of hay to enable the auger assembly to produce and discharge particles of hay.

36. The bale handler for round bales as recited in claim 35, further comprising:
a crane on the bed outside the storage area, said crane being able to extend its boom to place a bale of hay in the storage area of the bed.

37. The bale handler for round bales as recited in claim 36, further comprising:
a first storage tub in the storage area on the bed of said vehicle, said storage tub having sloped sides of such slope and dimensions as to accommodate round bales of hay with the lowest point of each bale being at the transverse center of said tub; and
wherein the crane is able to extend its boom to place a bale of hay in said first storage tub.

38. The bale handler for round bales as recited in claim 37, further comprising:
at least one additional storage tub laterally adjacent to said first storage tub, each of said additional storage tubs having sloped sides of such slope and dimensions as to accommodate bales of hay with the lowest point of each bale being substantially at the transverse center of said tub; and
wherein said crane is also able to extend its boom to place a bale of hay in any of said additional laterally adjacent storage tubs.

39. The bale handler for round bales as recited in claim 36, further comprising:
a first column of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
wherein the crane on the bed outside the storage area is able to extend its boom to place a bale of hay in any of the individual storage tubs.

40. The bale handler for round bales as recited in claim 39, further comprising:
at least one additional column of individual storage tubs in the storage area on the bed of said vehicle laterally adjacent to said first column of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the additional individual storage tubs.

41. The bale handler for round bales a recited in claim 5, wherein the means for grasping, lifting, and releasing comprises:
a mechanism support structure having a top, a bottom, a front, a left side, and a right side with one of the sides, near the top of such side, rotatably connected to the bed of the said vehicle;
at least one mechanism lifting cylinder having a first end rotatably attached to the side of said mechanism support structure that is nearer the bed of the bale handler and having a second end rotatably attached to said vehicle below where said mechanism support structure is rotatably connected to the bed of said vehicle;
a lower axle having a first end and a second end, said lower axle being attached to said mechanism support structure near the bottom and the front of said mechanism support structure;
a right vertical support member having a lower end and an upper end with the lower end of said right vertical support member being rotatably attached so said lower axle near the first end of said lower axle;
a left vertical support member having a lower end and an upper end with the lower end of said left right vertical support member being rotatably attached to said lower axle near the second end of said lower axle;
an upper axle having a first end and a second end, the first end of said upper axle being rotatable connected to and extending through said right vertical support member near the upper end of said right vertical support member, and the second end of said upper axle being rotatably connected to and extending through said left vertical support member near the upper end of said left vertical support member;
a first main lifting arm having a left side, a first end, and a second end, the first end of said first main lifting arm being attached to said upper axle near the first end of said upper axle but farther from the first end of said upper axle than where said right vertical support member is rotatably connected to said upper axle;
a second main lifting arm having a right side, a first end, and a second end, the first end of said second main lifting arm being attached to said upper axle near the second end of said upper axle but farther from the second end of said upper axle than where said left vertical support member is rotatably connected to said upper axle;
a right primary hydraulic cylinder having a first end and a second end, the first end of said right primary hydraulic cylinder being rotatably attached to said mechanism support structure near the bottom and on the right side of said mechanism support structure, and the second end of said right primary hydraulic cylinder being rotatably connected to the first end of said upper axle;
a left primary hydraulic cylinder having a first end and a second end, the first end of said left primary hydraulic cylinder being rotatably connected to said mechanism support structure near the bottom and on the left side of said mechanism support structure, and the second end of said left primary hydraulic cylinder being rotatably connected to the second end of said upper axle;
a right secondary hydraulic cylinder having a first end and a second end, the first end of said right secondary hydraulic cylinder being rotatably and slidably attached to said lower axle, and the second end of said right secondary hydraulic cylinder being rotatably connected to said first main lifting arm;
a left secondary hydraulic cylinder having a first end and a second end, the first end of said left secondary hydraulic cylinder being rotatably and slidably attached to said lower axle, and the second end of said left secondary hydraulic cylinder being rotatably connected to said second main lifting arm;
a first rotatable telescoping gripper having a first end attached to the left side of said first main lifting arm near the first end of said first main lifting arm, said first rotatable gripper also having a second end with projections located on such second end projects; and
a second rotatable telescoping gripper having a first end attached to the right side of said second main lifting arm near the first end of said second main lifting arm, said second rotatable gripper also having a second end with projections located on such second end.

42. The bale handler for round bales as recited in claim 41, further comprising:
a crane on the bed outside the storage area, said crane being able to extend its boom to place a bale of hay in the storage area of the bed.

43. The bale handler for round bales as recited in claim 42, further comprising:
a first storage tub in the storage area on the bed of said vehicle, said storage tub having sloped sides of such slope and dimensions as to accommodate round bales of hay with the lowest point of each bale being at the transverse center of said tub; and
wherein the crane is able to extend its boom to place a bale of hay in said first storage tub.

44. The bale handler for round bales as recited in claim 43, further comprising:
at least one additional storage tub laterally adjacent to said first storage tub, each of said additional storage tubs having sloped sides of such slope and dimensions as to accommodate bales of hay with the lowest point of each bale being substantially at the transverse center of said tub; and
wherein said crane is also able to extend its boom to place a bale of hay in any of said additional laterally adjacent storage tubs.

45. The bale handler for round bales as recited in claim 42, further comprising:
a first column of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
wherein the crane on the bed outside the storage area is able to extend its boom to place a bale of hay in any of the individual storage tubs.

46. The bale handler for round bales as recited in claim 45, further comprising:
at least one additional column of individual storage tubs in the storage area on the bed of said vehicle laterally adjacent to said first column of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the additional individual storage tubs.

47. The bale handler for round bales as recited in claim 41, wherein:
at least one of the first rotatable gripper and the second rotatable gripper is motorized.

48. The bale handler for round bales as recited in claim 47, further comprising:
a crane on the bed outside the storage area, said crane being able to extend its boom to place a bale of hay in the storage area of the bed.

49. The bale handler for round bales as recited in claim 48, further comprising:
a first storage tub in the storage area on the bed of said vehicle, said storage tub having sloped sides of such slope and dimensions as to accommodate round bales of hay with the lowest point of each bale being at the transverse center of said tub; and
wherein the crane is able to extend its boom to place a bale of hay in said first storage tub.

50. The bale handler for round bales as recited in claim 49, further comprising:
at least one additional storage tub laterally adjacent to said first storage tub, each of said additional storage tubs having sloped sides of such slope and dimensions as to accommodate bales of hay with the lowest point of each bale being substantially at the transverse center of said tub; and
wherein said crane is also able to extend its boom to place a bale of hay in any of said additional laterally adjacent storage tubs.

51. The bale handler for round bales as recited in claim 48, further comprising:
a first column of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
wherein the crane on the bed outside the storage area is able to extend its boom to place a bale of hay in any of the individual storage tubs.

52. The bale handler for round bales as recited in claim 51, further comprising:
at least one additional column of individual storage tubs in the storage area on the bed of said vehicle laterally adjacent to said first column of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the additional individual storage tubs.

53. The bale handler for round bales as recited in claim 47, further comprising:
an auger assembly attached to the bed of the bale handler so as to receive unrolled hay from said means for unrolling a round bale of hay to enable the auger assembly to produce and discharge particles of hay.

54. The bale handler for round bales as recited in claim 53, further comprising:
a crane on the bed outside the storage area, said crane being able to extend its boom to place a bale of hay in the storage area of the bed.

55. The bale handler for round bales as recited in claim 54, further comprising:
a first storage tub in the storage area on the bed of said vehicle, said storage tub having sloped sides of such slope and dimensions as to accommodate round bales of hay with the lowest point of each bale being at the transverse center of said tub; and
wherein the crane is able to extend its boom to place a bale of hay in said first storage tub.

56. The bale handler for round bales as recited in claim 55, further comprising:
at least one additional storage tub laterally adjacent to said first storage tub, each of said additional storage tubs having sloped sides of such slope and dimensions as to accommodate bales of hay with the lowest point of each bale being substantially at the transverse center of said tub; and
wherein said crane is also able to extend its boom to place a bale of hay in any of said additional laterally adjacent storage tubs.

57. The bale handler for round bales as recited in claim 54, further comprising:
a first column of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
wherein the crane on the bed outside the storage area is able to extend its boom to place a bale of hay in any of the individual storage tubs.

58. The bale handler for round bales as recited in claim 57, further comprising:
at least one additional column of individual storage tubs in the storage area on the bed of said vehicle laterally adjacent to said first column of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the additional individual storage tubs.

59. A bale handler for round bales, which comprises:
a vehicle having a bed with a storage area;
a mechanism support structure having a top, a bottom, a front, a left side, and a right side with one of the sides, near the top of such side, rotatably connected to the bed of the said vehicle;
at least one mechanism lifting cylinders having a first end rotatably attached to the side of said mechanism support structure that is nearer the bed of the bale handler and having a second end rotatably attached to said vehicle below where said mechanism support structure is rotatably connected to the bed of said vehicle;
a lower axle having a first end and a second end, said lower axle being attached to said mechanism support structure near the bottom and the front of said mechanism support structure;
a right vertical support member having a lower end and an upper end with the lower end of said right vertical support member being rotatably attached so said lower axle near the first end of said lower axle;
a left vertical support member having a lower end and an upper end with the lower end of said left right vertical support member being rotatably attached to said lower axle near the second end of said lower axle;
an upper axle having a first end and a second end, the first end of said upper axle being rotatable connected to and extending through said right vertical support member near the upper end of said right vertical support member, and the second end of said upper axle being rotatably connected to and extending through said left vertical support member near the upper end of said left vertical support member;
a first main lifting arm having a left side, a first end, and a second end, the first end of said first main lifting arm being slidably attached to said upper axle near the first end of said upper axle but farther from the first end of said upper axle than where said right vertical support member is rotatably connected to said upper axle;
a second main lifting arm having a right side, a first end, and a second end, the first end of said second main lifting arm being slidably attached to said upper axle near the second end of said upper axle but farther from the second end of said upper axle than where said left vertical support member is rotatably connected to said upper axle;
a right primary hydraulic cylinder having a first end and a second end, the first end of said right primary hydraulic cylinder being rotatably attached to said mechanism support structure near the bottom and on the right side of said mechanism support structure, and the second end of said right primary hydraulic cylinder being rotatably connected to the first end of said upper axle;
a left primary hydraulic cylinder having a first end and a second end, the first end of said left primary hydraulic cylinder being rotatably connected to said mechanism support structure near the bottom and on the left side of said mechanism support structure, and the second end of said left primary hydraulic cylinder being rotatably connected to the second end of said upper axle;
a right secondary hydraulic cylinder having a first end and a second end, the first end of said right secondary hydraulic cylinder being rotatably and slidably attached to said lower axle, and the second end of said right secondary hydraulic cylinder being rotatably connected to said first main lifting arm;
a left secondary hydraulic cylinder having a first end and a second end, the first end of said left secondary hydraulic cylinder being rotatably and slidably attached to said lower axle, and the second end of said left secondary hydraulic cylinder being rotatably connected to said second main lifting arm;
a right spreader hydraulic cylinder having a housing attached to said upper axle between said first main lifting arm and said second main lifting arm, said right spreader hydraulic cylinder also having a piston with the piston having a free end connected to said first main lifting arm;
a left spreader hydraulic cylinder having a housing attached to said upper axle between said first main lifting arm and said second main lifting arm, said left spreader hydraulic cylinder also having a piston with the piston having a free end connected to said second main lifting arm;
a first motorized rotatable gripper having a first end attached to the left side of said first main lifting arm near the first end of said first main lifting arm, said first rotatable gripper also having a second end with projections located on such second end projects;
a second motorized rotatable gripper having a first end attached to the right side of said second main lifting arm near the first end of said second main lifting arm, said second rotatable gripper also having a second end with projections located on such second end;
a crane on the bed outside the storage area, said crane being able to extend its boom to place a bale of hay in the storage area of the bed;
at least two laterally adjacent columns of individual storage tubs in the storage area on the bed of said vehicle of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the individual storage tubs.

60. A bale handler for round bales, which comprises:
a vehicle having a bed with a storage area;
a mechanism support structure having a top, a bottom, a front, a left side, and a right side with one of the sides, near the top of such side, rotatably connected to the bed of the said vehicle;
at least one mechanism lifting cylinders having a first end rotatably attached to the side of said mechanism support structure that is nearer the bed of the bale handler and having a second end rotatably attached to said vehicle below where said mechanism support structure is rotatably connected to the bed of said vehicle;
a lower axle having a first end and a second end, said lower axle being attached to said mechanism support structure near the bottom and the front of said mechanism support structure;
a right vertical support member having a lower end and an upper end with the lower end of said right vertical support member being rotatably attached so said lower axle near the first end of said lower axle;
a left vertical support member having a lower end and an upper end with the lower end of said left right vertical support member being rotatably attached to said lower axle near the second end of said lower axle;
an upper axle having a first end and a second end, the first end of said upper axle being rotatable connected to and extending through said right vertical support member near the upper end of said right vertical support member, and the second end of said upper axle being rotatably connected to and extending through said left vertical support member near the upper end of said left vertical support member;
a first main lifting arm having a left side, a first end, and a second end, the first end of said first main lifting arm being attached to said upper axle near the first end of said upper axle but farther from the first end of said upper axle than where said right vertical support member is rotatably connected to said upper axle;
a second main lifting arm having a right side, a first end, and a second end, the first end of said second main lifting arm being attached to said upper axle near the second end of said upper axle but farther from the second end of said upper axle than where said left vertical support member is rotatably connected to said upper axle;
a right primary hydraulic cylinder having a first end and a second end, the first end of said right primary hydraulic cylinder being rotatably attached to said mechanism support structure near the bottom and on the right side of said mechanism support structure, and the second end of said right primary hydraulic cylinder being rotatably connected to the first end of said upper axle;
a left primary hydraulic cylinder having a first end and a second end, the first end of said left primary hydraulic cylinder being rotatably connected to said mechanism support structure near the bottom and on the left side of said mechanism support structure, and the second end of said left primary hydraulic cylinder being rotatably connected to the second end of said upper axle;
a right secondary hydraulic cylinder having a first end and a second end, the first end of said right secondary hydraulic cylinder being rotatably and slidably attached to said lower axle, and the second end of said right secondary hydraulic cylinder being rotatably connected to said first main lifting arm;
a left secondary hydraulic cylinder having a first end and a second end, the first end of said left secondary hydraulic cylinder being rotatably and slidably attached to said lower axle, and the second end of said left secondary hydraulic cylinder being rotatably connected to said second main lifting arm;
a first motorized telescopic rotatable gripper having a first end attached to the left side of said first main lifting arm near the first end of said first main lifting arm, said first rotatable gripper also having a second end with projections located on such second end projects;
a second motorized telescopic rotatable gripper having a first end attached to the right side of said second main lifting arm near the first end of said second main lifting arm, said second rotatable gripper also having a second end with projections located on such second end;
a crane on the bed outside the storage area, said crane being able to extend its boom to place a bale of hay in the storage area of the bed;
at least two laterally adjacent columns of individual storage tubs in the storage area on the bed of said vehicle of individual storage tubs with each of the additional individual storage tubs having sloped sides of such slope and dimensions as to accommodate traditional round bales of hay with the lowest point of the bale being at the transverse center of the tub and with each of the additional individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional individual storage tub; and
wherein said crane is also able to extend its boom to place a bale of hay anywhere in any of the individual storage tubs.

61. A bale handler for round bales, which comprises:
a vehicle having a bed with a bale-carrying portion which is lower than the remainder of the bed;
two columns of individual storage tubs in the storage area on the bed of said vehicle with each of the individual storage tubs having sloped sides of such slope and dimensions as to accommodate traditional round bales of hay with the lowest point of the bale being at the transverse center of the tub and with each of the individual storage tubs having a sloped forward end with a bottom and a sloped rear end having a bottom with the distance between the bottom of the sloped forward end and the bottom of the sloped rear end being substantially equal to the length of a traditional round bale of hay intended to be carried by the additional storage tub; and
a crane on the remainder of the bed, said crane being able to extend its boom to place a bale of hay in any of the individual storage tubs.

62. The bale handler for round bales as recited in claim 61, further comprising:
a front brace post removably placed in front of each columns of individual storage tubs;
a side brace post removably placed at each side of each row of two individual storage tubs;
a middle brace post removably place between laterally adjacent individual storage tubs; and
a rear post frame attached to said vehicle behind said two columns of individual storage tubs.
